(19) United States
(12) Patent Application Publication
(10) Pub. No.: US 2026/0260220 A1
(43) Pub. Date: Sep. 3, 2026

(54) REUSE OF PRODUCTS

(71) Applicant: BASF SE, Ludwigshafen am Rhein (DE)

(72) Inventors: Thorsten DIKMANN, Muenster (DE); Holger Kai Peter JELICH, Ludwigshafen am Rhein (DE); Nicole GRAF, Ludwigshafen am Rhein (DE); Claudia Elena HERRERA GARCIA, Madrid (ES); Stefan HANNEMANN, Ludwigshafen am Rhein (DE); Timo WENDLING, Ludwigshafen (DE); Michael-Georg SCHMIDT, Ludwigshafen (DE)

(21) Appl. No.: 19/155,826

(22) PCT Filed: Feb. 14, 2024
(86) PCT No.: PCT/IB2024/051372

§ 371 Date: Aug. 12, 2025

(30) Foreign Application Priority Data
Feb. 14, 2023 (EP) 23156530.0

(51) Int. Cl. G06Q 10/30

(52) U.S. Cl. CPC G06Q 10/30

(57) ABSTRACT

The disclosure relates to the field of sustainability, in particular the re-use of products. Disclosed are methods, apparatuses, systems and re-use instructions or control data configured to control re-use of at least one used product such as at least one used tire as well as chemical input material(s) produced from the at least one used product such as at least one used tire by using the control data.

### TECHNICAL FIELD

The disclosure relates to the field of sustainability, in particular the re-use of products. Disclosed are methods, apparatuses, systems and re-use instructions or control data configured to control re-use of at least one used product such as at least one used tire as well as chemical input material(s) produced from the at least one used product such as at least one used tire by using the control data.

### TECHNICAL BACKGROUND

Chemical products are used in diverse applications and end up in multiple supply chains. Used products containing chemical products are not easily re-useable. This hampers to reliably refeed used products into re-use chains and the built up of circular ecosystems.

### SUMMARY

In one aspect a method, particularly a computer-implemented method, for processing at least one used product, e.g. for generating control and/or monitoring data for processing, the method comprising the steps:
providing at least one re-use trigger including at least one decentral identifier associated with the used product;
collecting at least one physical and/or chemical property of the used product, wherein the physical and/or chemical property is a measured property of the used product and/or wherein the physical and/or chemical property is determined from product data collected via the at least one decentral identifier associated with the used product;
generating control and/or monitoring data by correlating and/or relating the at least one physical and/or chemical property of the used product to processing properties of one or more apparatus(es) configured to re-use the used product and/or by generating machine-readable instructions for processing the used product by one or more apparatus(es) configured to re-use the used product;
providing the control and/or monitoring data including the machine-readable instructions for processing the used product by one or more apparatus(es) configured to re-use the used product.

In another aspect an apparatus for processing at least one used product, e.g. for generating control and/or monitoring data for processing, the apparatus configured to perform the steps below or
an apparatus for processing at least one used product, e.g. for generating control and/or monitoring data for processing, wherein the at least one used product is controlled and/or monitored via peer-to-peer communication between computing node(s) of a decentral network, the apparatus comprising one or more computing node(s) and one or more computer-readable media having thereon computer-executable instructions that are structured such that, when executed by the one or more computing node(s), cause the apparatus to perform the steps below:
   providing at least one re-use trigger including at least one decentral identifier associated with the used product;
   collecting at least one physical and/or chemical property of the used product, wherein the physical and/or chemical property is a measured property of the used product and/or wherein the physical and/or chemical property is determined from product data collected via the at least one decentral identifier associated with the used product;
   generating control and/or monitoring data by correlating and/or relating the at least one physical and/or chemical property of the used product to processing properties of one or more apparatus(es) configured to re-use the used product and/or by generating machine-readable instructions for processing the used product by one or more apparatus(es) configured to re-use the used product;
   providing the control and/or monitoring data including the machine-readable instructions for processing the used product by one or more apparatus(es) configured to re-use the used product.

In another aspect an apparatus for processing at least one used product, e.g. for generating control and/or monitoring data for processing, the apparatus comprising:
a trigger provider configured to provide at least one re-use trigger including at least one decentral identifier associated with the used product;
a data collector configured to collect at least one physical and/or chemical property of the used product, wherein the physical and/or chemical property is a measured property of the used product and/or wherein the physical and/or chemical property is determined from product data collected via the at least one decentral identifier associated with the used product;
a control data generator configured to generate control and/or monitoring data by correlating and/or relating the at least one physical and/or chemical property of the used product to processing properties of one or more apparatus(es) configured to re-use the used product and/or by generating machine-readable instructions for processing the used product by one or more apparatus(es) configured to re-use the used product;
a control and/or monitoring data provider configured to provide the control and/or monitoring data including the machine-readable instructions for processing the used product by one or more apparatus(es) configured to re-use the used product.

In another aspect disclosed is a system for processing at least one used product, the system comprising:
an apparatus for generating control and/or monitoring data for processing at least one used product as disclosed herein and/or
at least one of the following apparatuses configured to receive the control and/or monitoring data generated by the apparatuses e.g. according to the methods disclosed herein: one or more apparatus(es) configured to re-use the used product;
a physical treatment apparatus for refurbishing the at least one used product or part(s) thereof;
a chemical and/or physical treatment apparatus for recycling the used product or part(s) thereof;
a chemical and/or physical treatment apparatus for recovering chemical material from the used product or part(s) thereof.

In yet another aspect disclosed is a method, particularly a computer-implemented method, for processing at least one used product, e.g. for generating control and/or monitoring data for processing, wherein the at least one used product is controlled and/or monitored via peer-to-peer communication between computing node(s) of a decentral network, the method comprising the steps:
providing at least one re-use trigger including at least one decentral identifier associated with the used product;
collecting at least one physical and/or chemical property of the used product, wherein the physical and/or chemical property is a measured property of the used product and/or wherein product data is collected via the at least one decentral identifier e.g. from one or more computing node(s) or participant node(s) of a decentral network, wherein the physical and/or chemical property is determined from the product data;
generating control and/or monitoring data by correlating and/or relating the at least one physical and/or chemical property of the used product to processing properties of one or more apparatus(es) configured to re-use the used product and/or by generating machine-readable instructions for processing the used product by one or more apparatus(es) configured to re-use the used product;
providing the control and/or monitoring data including the machine-readable instructions to one or more computing node(s) of the decentral network, wherein the computing node(s) are configured to initialize a process for re-using the at least one used product.

In yet another aspect disclosed is an apparatus for processing at least one used product, e.g. e.g. for generating control and/or monitoring data for processing, wherein the at least one used product is controlled via peer-to-peer communication between computing node(s) of a decentral network, the apparatus configured to perform the steps below: or
an apparatus for processing at least one used product, e.g. for generating control and/or monitoring data for processing, wherein the at least one used product is controlled via peer-to-peer communication between computing node(s) of a decentral network, the apparatus comprising one or more computing node(s) and one or more computer-readable media having thereon computer-executable instructions that are structured such that, when executed by the one or more computing node(s), cause the apparatus to perform the steps below:
   providing at least one re-use trigger including at least one decentral identifier associated with the used product;
   collecting at least one physical and/or chemical property of the used product, wherein the physical and/or chemical property is a measured property of the used product and/or wherein product data is collected via the at least one decentral identifier from one or more participant node(s) of a decentral network, wherein the physical and/or chemical property is determined from the product data;
   generating control and/or monitoring data by correlating and/or relating the at least one physical and/or chemical property of the used product to processing properties of one or more apparatus(es) configured to re-use the used product and/or by generating machine-readable instructions for processing the used product by one or more apparatus(es) configured to re-use the used product;
   providing the control and/or monitoring data including the machine-readable instructions to one or more computing node(s) of the decentral network, wherein the computing node(s) are configured to initialize a process for re-using the at least one used product.

Furthermore in other aspects disclosed are a method, particularly a computer-implemented method, for generating control and/or monitoring data for re-using at least one used product, the method comprising the steps below or
an apparatus for generating control and/or monitoring data for re-using at least one used product, the apparatus being configured to perform the steps below or
an apparatus for generating control and/or monitoring data for re-using at least one used product, wherein the at least one used product is controlled via peer-to-peer communication between computing node(s) of a decentral network, the apparatus comprising one or more computing node(s) and one or more computer-readable media having thereon computer-executable instructions that are structured such that, when executed by the one or more computing node(s), cause the apparatus to perform any of the steps below:
   providing at least one re-use trigger including at least one decentral identifier associated with the used product and status data associated with at least one property of the used product;
   collecting via the at least one decentral identifier product data e.g. from one or more computing node(s) or participant node(s) of a decentral network, wherein the product data relates to production and/or use of the used product;
   generating, based on the at least one re-use trigger and the collected product data, control and/or monitoring data for re-using the at least one used product; providing the control and/or monitoring data to initialize a process for re-using the at least one used product.
and/or any of the steps below:
   providing at least one re-use trigger including at least one decentral identifier associated with the used product and status data associated with at least one property of the used product;
   collecting via the at least one decentral identifier product data e.g. from one or more computing node(s) or participant node(s) of a decentral network, wherein the product data relates to production and/or use of the used product;
   generating, based on the at least one re-use trigger and the collected product data, control and/or monitoring data for re-using the at least one used product;
   providing the control and/or monitoring data to one or more computing node(s) of the decentral network, wherein the computing node(s) are configured to initialize a process for re-using the at least one used product.

In yet another aspect disclosed is a system for controlling and/or monitoring re-use of at least one used product, the system comprising:
an apparatus for processing or controlling re-use of the at least one used product as disclosed herein;
optionally a product collector configured to receive control and/or monitoring data to initialize a process for re-using the at least one used product or part(s) thereof;
optionally a plant operator of a chemical and/or physical treatment plant configured to receive the control and/or monitoring data to initialize a process for re-using the at least one used product or part(s) thereof, wherein the operator of the chemical and/or physical treatment plant may be associated with a chemical product producer, a product manufacturer and/or a product re-user;
optionally a chemical and/or physical treatment plant for recycling the at least one used product or part(s) thereof to recover chemical material, wherein the chemical and/or physical treatment plant may be associated with a chemical product producer, a product manufacturer and/or a product re-user.

In another aspect disclosed are re-use instruction(s) or control and/or monitoring data configured to control and/or monitor re-use of at least one used product, e.g. as generated and/or used, according to the methods disclosed herein or by the apparatuses or systems disclosed herein.

In another aspect disclosed are one or more chemical material(s) produced from at least one used product or part(s) thereof by using the control and/or monitoring data, e.g. generated and/or used, according to the methods disclosed herein or by the apparatuses or systems disclosed herein.

In another aspect disclosed is a system including at least one used product and control and/or monitoring data configured to or used to control and/or monitor re-use of at least one used product according to the methods disclosed herein or by the apparatuses or systems disclosed herein, wherein the at least one used product is associated with the control and/or monitoring data.

In another aspect disclosed are control and/or monitoring data consuming service(s) and/or control and/or monitoring data providing service(s) configured to control and/or monitor re-use of at least one used product, according to the methods disclosed herein or by the apparatuses or systems disclosed herein.

In another aspect disclosed are control and/or monitoring data providing service(s) configured to generate control and/or monitoring data for controlling and/or monitoring re-use of at least one used product, according to the methods disclosed herein or the apparatuses or systems disclosed herein.

In another aspect disclosed is the use of the control and/or monitoring data provided according to the methods disclosed herein or by the apparatuses or systems disclosed herein to control and/or monitor re-use of at least one used product, and/or to refeed chemical material recovered from the re-use of the at least one used product into one or more chemical production process(es).

In another aspect the present disclosure relates to a computer element, such as a computer program or computer readable medium, with instructions, which when executed on one or more computing node(s) e.g. of a decentral network are configured to carry out the steps of the method(s) disclosed herein or are configured to be carried out by the apparatuses or systems disclosed herein.

Any disclosure, embodiments and examples described herein relate to the methods, the systems, apparatuses, products, chemical materials, instructions, uses, consuming services, providing services and computer elements lined out above and below. Advantageously, the benefits provided by any of the embodiments and examples equally apply to all other embodiments and examples.

### EMBODIMENTS

To reliably re-use products and to decrease the environmental impact of products, control and/or monitoring data generation for controlling and/or monitoring re-use in a data-driven manner is proposed. In particular, the re-use may be structured such that used products may be either repurposed for the same or other use or refed into chemical infrastructure. By using a data-driven approach that incorporates the history of used products, the re-use can be controlled by taking the specifics of the used product into account to minimize environmental impact. This way material flows may be controlled from collecting of used products to treating of used products up to reusing chemical materials recycled from used products. The approach proposed herein allows to reliably reuse products up to the refeed of chemical materials back into their chemical production chains. Hence, circular value chains may be enabled reducing the environmental impact of material flows.

In the following, embodiments of the present disclosure will be outlined by ways of examples. It is to be understood that the present disclosure is not limited to said embodiments and/or examples.

The used product may include any end product of a product ecosystem that may be used by an end user. The used product may relate to a manufactured product used by the end user. The product or used product may include any product with a carbon content. The product or used product may contain or be produced from at least one organic compound. The product or used product may include products containing extruded foams and/or textiles such as mattresses. The product or used product may include products containing rubber, silica, carbon black, steel and/or textiles such as tires. The product or used product may include products containing any type of plastics such as packaging material or plastics toys. The product or used product may include products containing any type of metals such as precious metals. The used product may be a used product with a carbon content, a used product containing at least one organic com-pound, a used product containing metals such as precious metals, a used battery, an electronics device, a used car, a used textile, a used mattress, a used car component or a used tire. In the disclosure terms relating to product such as product data, product user, product producer, or the like may be similarly used in the context of specific products and the product may be specified by the specific product. For example, in the case of tires, product data may be tire data, the product user may be a tire user, the product producer may be a tire producer and the like. Or for example in the case of batteries, the product data may be battery data, the product user may be a battery user, the product producer may be a battery producer and the like.

The product ecosystem may include different stages including manufacturing, use and re-use. In these stages one or more ecosystem participant(s) may contribute to the manufacture, use or re-use of the product. For example, the manufacturing stage may include raw material manufacturers, intermediate material manufactures and/or end-product manufacturers. Further for example, the use stage may include product user, product maintainers and/or product distributors. Further for example, the re-use stage may include collectors, sorters, dismantlers, recyclers, re-storers and/or re-furbishers.

The participants of the product ecosystem may be connected via a decentral network. The decentral network may include computing nodes associated with participants of the product ecosystem and may be configured to perform data transactions. The computing nodes associated with participants of the product ecosystem may be associated with producers, users or re-users of physical products, such as chemical product producers, intermediate product producers, end product producers, end product users, used product users or product re-users. The data transactions may be based on a transaction protocol including authentication and/or authorization mechanism(s). Based on the authentication and/or authorization mechanism(s) a peer-to-peer communication between computing nodes associated with participants of the product ecosystem may be established. The respective nodes of the decentral network associated with the participants of the product ecosystem may be configured as trigger consuming service(s), trigger providing service(s), control and/or monitoring data consuming service(s), control and/or monitoring data providing service(s), product data providing service(s) and/or product data consuming service(s).

The one or more authentication mechanism(s) may be associated with or linked to the decentral identifier associated with the physical entity of the product. The one or more authentication mechanism(s) associated with the decentral identifier may be provided to participant node(s). The one or more authentication mechanism(s) associated with the decentral identifier may be accessible by the data providing service and/or the data consuming service. The decentral configuration allows for more efficient use of computing resources and strengthens control by the data owners of the decentral network.

The one or more authorization mechanism(s) may include at least one authorization rule for controlling access to data under control by the data owners. The computing nodes associated with participants of the product ecosystem may be configured to provide data consuming service(s) and/or data providing service(s). A data providing service may be configured to provide or send data to another participant node of the decentral network. A data consuming service may be configured to ingest or receive data from another participant node of the decentral network. Providing data to a data providing service for access by a data consuming service may include indirect or direct access of the data consuming service to the data.

The re-use trigger may relate to a trigger associated with an end-of-life event of the used product. The re-use trigger may relate to reuse of the used product. The re-use trigger may be generated based on the end-of-life event for the used product. The end-of-life event may be predefined e.g. by time lapse or may be user defined e.g. by indicating the end-of-life. The re-use trigger may be generated by at least one node of the decentral network. Such node may be associated with the user of the used product or the collector of the used product. The re-use trigger may include at least one decentral identifier associated with the used product. The re-use trigger may be generated on reading a physical identifier associated with the used product. The physical identifier may be connected to or physically attached to the product, e.g. via a identification number, an electronic tag such as an RFID tag or a code such as a QR code. The physical identifier may be connected to the decentral identifier associated with the used product. The re-use trigger may be generated based on a pre-determined criterium such as a pre-determined use time period, a pre-determined location and/or a pre-determined event. The decentral identifier associated with the used product may be provided for generation of the re-use trigger.

The re-use trigger may include or relate to status data associated with at least one property of the used product. The status data may signify at least one property of the used product in its used state. The status data may include or relate to the at least one physical and/or chemical property of the used product. The status data may include or relate to at least one physical and/or chemical property related to the type of the used product or materials contained in the used product. The status data may include or relate to at least one physical and/or chemical property related to the use state of the used product. The status data may include or relate to at least one physical and/or chemical property related to the location of the used product.

The at least one physical and/or chemical property of the used product may relate to one or more properties determined at the end-of-life of the used product. End-of-life in this context may refer to the used product not being usable for its current purpose or by its current user anymore. The at least one physical and/or chemical property of the used product may relate to one or more properties determined during the production and/or lifecycle of the used product. The at least one physical and/or chemical property of the used product may be derived from measurement and/or data accessible via the at least one decentral identifier associated with the used product. For example, the at least one physical and/or chemical property of the used product may be measured at the end-of-life to determine the status of the used product at the end-of-life. Further for example, the at least one physical and/or chemical property of the used product may be measured or derived from product data collected at any point during the production and/or lifecycle of the used product.

The control and/or monitoring data may be generated by correlating or relating the status data, in particular the at least one chemical and/or physical property, of the used product to processing properties of one or more apparatus(es) configured to re-use the used product and/or by generating machine-readable instructions for processing the used product by one or more apparatus(es) configured to re-use the used product. The processing properties may signify the properties of the used product suitable for re-use by one or more apparatus(es) configured for respective re-use. The processing properties may relate to one or more chemical and/or physical properties of the used product. The processing properties may relate to the reuse of the used product by apparatuses configured for respective reuse. Hence the processing properties may relate the chemical and/or physical properties of the unused product to the respective re-use. The machine-readable instructions for processing the used product by one or more apparatus(es) configured to re-use the used product may relate to the providing of the used product to the apparatus(es) configured for respective re-use. For example, the location of the used product and the apparatus configured for respective reuse may be related for controlling and/or monitoring providing of the used product to the apparatus configured for respective reuse or in other words the transportation of the used product to the apparatus configured for respective re-use.

In one embodiment the at least one physical and/or chemical property is collected by an optical measurement of the at least one physical and/or chemical property. The at least one physical and/or chemical property may be provided in relation to or together with the at least one re-use trigger e.g. as part of the status data. The physical and/or chemical property may include a property provided by sensors configured to measure the physical and/or chemical property. For example, the physical and/or chemical property may include a property provided by sensors of a mobile device such as a camera or an infrared spectrometer, such as a near-infrared spectrometer. The measurement and the providing of the physical and/or chemical property may be triggered by receipt of the reuse trigger. For example, a user may be guided for measurement e.g. the taking of images or the measurement with the infrared spectrometer. The measurement and the providing of the physical and/or chemical property may be provided together with the reuse trigger.

In another embodiment the physical and/or chemical property is determined from product data collected via the at least one decentral identifier associated with the used product. The at least one physical and/or chemical property may be provided in relation to or together with the at least one re-use trigger e.g. as part of the status data. The data collection and the providing of the physical and/or chemical property may be triggered by receipt of the reuse trigger. The product data may be provided together with the reuse trigger.

Decentral identifier(s) may connect the physical entity of the product or used product to product data related to the product or used product. The product data related to the product or the used product may relate to different stages of the product ecosystem. The product data may relate to historic information or data e.g. associated with the use and/or production of the product, gathered in different stages of the product ecosystem in relation to the used product. The product data related to the used product may be stored by or with respect to one or more node(s) associated with participants of the product ecosystem. The product data may be distributed across multiple nodes of the decentral network associated with different participants of the product ecosystem. The used product may relate to one or more decentral identifier(s) signifying the digital twin of the physical entity of the product. The decentral identifier(s) may be digital identifier(s) for the used product in or for the decentral network. The decentral identifier(s) may include one or more digital identifier(s) provided to the decentral network and/or computing nodes associated with participants of the product ecosystem. The decentral identifier(s) may signify physical entities of the product or used product for participant node(s) of the decentral network. The decentral identifier(s) may be linked according to a physical relation of the physical product entity or used product entity with other physical entities e.g. those used to produce the product or the used product or those the product or the used product is used with or in relation to. This way participant node(s) of the decentral network may be able to interpret the relation of the decentral identifier(s) corresponding to the physical relation of the physical product entity or used product entity to other physical entities. The linking of the decentral identifier(s) allows to determine the node(s) storing the product data.

The decentral network may be configured to provide access to product data stored by one or more node(s) associated with at least one participant of the product ecosystem. The access may be provided according to a decentral network protocol including authentication and/or authorization. The product data collection may include providing at least one request to one or more node(s) associated with participants of the product ecosystem based on decentral identifier(s). For collection, the node may be selected based on a linking of the at least one decentral identifier associated with the used product to at least one other decentral identifier associated with physical entities the used product is or was physically related to.

The product data may be collected from one or more network node(s) associated with product producers and/or users connected via a decentral network. The network node the product data are to be collected from may be selected based on the decentral identifier associated with the used product. The product data may be collected via the at least one decentral identifier from one or more node(s) associated with one or more producer(s) or one or more users of the product. The product data may be provided via the at least one decentral identifier from one or more node(s) associated with one or more producer(s) or one or more user(s) of the product. The product data may include production data provided by one or more producer(s) of the used product and/or monitoring data provided by one or more user(s) of the used product.

In one embodiment at least one physical and/or chemical property may be collected by requesting product data associated with the used product via the at least one decentral identifier associated with the used product. The requested product data may relate to monitoring data collected during use of the product. The physical and/or chemical property may be determined from the monitoring data. The requested product data may relate to production data collected on production of the product. The physical and/or chemical property may be determined from the production data. The physical and/or chemical property may be determined from the monitoring data and/or the production data.

The product data may be associated with historic data related to the production of the used product. The production data may relate to one or more material composition(s) used to produce the used product or part(s) thereof. The product data may include composition data associated with the used product or part(s) thereof.

The product data may be associated with historic data related to the use of the used product. The monitoring data may relate to at least one physical and/or chemical property impacted by the use of the product or part(s) thereof. The at least one physical and/or chemical property impacted by the use may be derived from monitoring data. The product data may include the at least one physical and/or chemical property derived from monitoring data and/or the monitoring data.

In one embodiment the processing properties of one or more apparatus(es) are collected from one or more network node(s) associated with product re-users connected via a decentral network. The network node the processing properties of one or more apparatus(es) are to be collected from may be selected based on at least one property of the used product. Processing properties may relate to the re-use process performed by the apparatus and/or physical and/or chemical properties of the used product. This way the physical and/or chemical properties of the used product may be matched by way of the processing properties to the respective apparatus configured for reuse.

In one embodiment the one or more apparatus(es) configured to re-use the used product process the used product by re-purposing, refurbishing or recycling the used product. The processing properties of the one or more apparatus(es) configured to re-purpose or refurbish the used product may relate at least to one physical property of the used product. The processing properties of the one or more apparatus(es) configured to re-purpose or refurbish the used product may relate to at least one damage state of the used product. The processing properties of the one or more apparatus(es) configured to recycle the used product may relate at least to one chemical property of the used product. The processing properties of the one or more apparatus(es) configured to recycle the used product may relate to at least one material type contained in the used product.

In one embodiment recyclate data related to one or more recyclate composition(s) to be refed into the production of the one or more producer(s) is collected, wherein control and/or monitoring data is generated by correlating and/or relating the at least one physical and/or chemical property of the used product to recyclate data. The recyclate data may relate to recyclate flows associated with recyclate producible via recycling of the used product or part(s) thereof. For example, recyclate data may be collected from one or more node(s) associated with one or more producer(s), such as chemical producer(s) or product producer(s). The collection may include using the at least one decentral identifier of the used product and/or product data such as material compositions data. Recyclate data may relate to one or more recyclate composition(s) to be refed into the production of the one or more producer(s). Recyclate data may for a recyclate composition relate to a quantity of recyclate to be refed into the production of the one or more producer(s). The quantity may signify a demand for one or more recyclate composition(s).

The control and/or monitoring data may be generated by matching the production data related to one or more material composition(s) contained in the used product or part(s) thereof with recyclate data related to one or more recyclate composition(s) to be refed into the production of the one or more producer(s). Based on matching, control and/or monitoring data for producing the matching recyclate composition may be generated. The control and/or monitoring data may relate to used products for producing the recyclate e.g. demanded and/or to be refed into the production of the one or more producer(s). The control and/or monitoring data may include one or more decentral identifiers associated with used products for producing the recyclate e.g. demanded and/or to be refed into the production of the one or more producer(s). The control and/or monitoring data may include the machine-readable instructions for processing the used product.

In another embodiment the control and/or monitoring data, such as the machine-readable instructions for processing the used product, include at least one decentral identifier associated with at least one apparatus configured to re-use the used product and/or at least one decentral identifier associated with the used product. The control and/or monitoring data and/or machine-readable instructions may further include instructions for treating the used product. The control and/or monitoring data and/or instruction may relate to repurposing of the used product. The control and/or monitoring data and/or instruction may relate to re-furbishing or second use of the used product. The control and/or monitoring data and/or instruction may relate to recycling of the used product.

The control and/or monitoring data may be configured to provide the used product or at least one part(s) thereof to a chemical and/or physical treatment plant associated with a producer, such as a chemical product producer or a product producer, or a recycler. The control and/or monitoring data may be associated with one or more process step(s) to reuse the used product. The control and/or monitoring data may relate to a chemical and/or physical treatment of the used product or part(s) thereof to recover the chemical material as recyclate. The control and/or monitoring data may relate to chemical and/or physical treatment method(s) suitable for treating the used product or part(s) thereof to produce recyclate. The control and/or monitoring data may be configured to initialize a process for re-using the at least one used product. The control and/or monitoring data may be provided to one or more node(s) of the decentral network, wherein the one or more node(s) may be associated with re-users for e.g. re-purpose, re-furbish, recycle and/or re-produce. The control and/or monitoring data may include specification of the re-use method, such as recycling method, to be produced recyclate, recycler identifier and/or chemical producer identifier related to chemical producer using recyclate as input material to produce new output material. Based on the generated control and/or monitoring data the process for reuse to e.g. re-purpose, re-furbish, recycle and/or re-produce the used product may be initialized and/or controlled.

The re-use trigger may be generated by a node associated with a participant triggering the end-of-life event related to the used product. For generation of the re-use trigger, the identification of the used product may be read through an ID reader or may be manually entered into an application such as a mobile app.

Based on providing the used product identification the decentral identifier associated with the used product may be retrieved via the decentral network. For example, the used product identification may be provided to a decentral data base or a decentral registry storing the decentral identifiers in connection with the used product identification. The decentral database may be a data base including decentral identifiers for used products. The decentral database may include a distributed ledger and may allow for verification of the product identifier. Further for example, the decentral identifier may be retrieved from a registry storing the decentral identifiers in connection with the used product identification and associated with the participant triggering the re-use trigger. Further for example, the decentral identifier may be fetched from a registry associated with any participant of the product ecosystem, such as the product producer or the product user. The participant triggering the re-use event may connect via authentication and/or authorization protocols of the decentral network to nodes associated with other participants of the product ecosystem as for example described in the context of FIG. 4 or 5.

The re-use trigger may include the decentral identifier associated with the product and status data associated with the used product. The status data may include characteristics of the used product declaring end-of-life. This may include visual inspection data such as image data as for example provided from smart phone camera.

The re-use trigger including the decentral identifier associated with the used product may be provided to any node associated with a participant of the product ecosystem collecting products.

For example, the re-use trigger may be provided to the node associated with the product producer, the chemical producer supplying the product production chain or the recycler. The re-use trigger may be sent to the node associated with the respective participant.

Based on the providing of the re-use trigger control and/or monitoring data associated with the re-use of the used product may be generated. To generate control and/or monitoring data further data in particular relating to at least one physical and/or chemical property of the used product may be retrieved from nodes associated with different participants of the product ecosystem. For example, product production data including composition data associated with the materials making up the used product may be retrieved from the producer of the product. Further for example, product use data including monitoring data associated with the product during its use may be retrieved from nodes associated with product users. Further for example, product use data including lifetime data associated with the product may be retrieved. Further for example, sensor data associated with a measured property of the used product may be retrieved from any node. This way physical and/or chemical properties of the used product may be collected. The physical and/or chemical properties may be measured properties of the used product such as image or IR sensor data. The physical and/or chemical properties may be determined from product data collected via the at least one decentral identifier associated with the used product, such as the composition data or use data related to monitoring data from use or lifetime of the product.

The control and/or monitoring data may be generated by correlating and/or relating the at least one physical and/or chemical property of the used product to processing properties of one or more apparatus(es) configured to re-use the used product and/or by generating machine-readable instructions for processing the used product by one or more apparatus(es) configured to re-use the used product. Processing properties may relate to the re-use process performed by the apparatus. In dependence of the provided physical and/or chemical property, the processing properties required for re-use and with that the suitable apparatus(es) configured to re-use the used product may be determined. Apparatus(es) configured for re-use the used product, process the used product by re-purposing, refurbishing or recycling the used product.

The processing properties of the one or more apparatus(es) configured to re-purpose or refurbish the used product may depend on physical properties. The physical property may be provided through measurement such as one or more images showing the product.

The processing properties of the one or more apparatus(es) configured to recycle the used product may relate at least to one chemical property of the used product. The chemical property such as product composition or content of specific components of the product may be provided through the peer-to-peer communication network upon request and data transfer between nodes of the decentral network.

The processing properties of the one or more apparatus(es) that are being matched with the physical and/or chemical properties of the used product may be stored in a central or decentral data base or storage. The processing properties may be collected from one or more network node(s) associated with product re-users connected via a decentral network. The network node the processing properties of one or more apparatus(es) are to be collected from may be selected based on at least one property provided for the used product. Suitable apparatus(es) configured for re-use may be selected based on such matching. This way by correlating and/or relating the at least one physical and/or chemical property of the used product to processing properties of one or more apparatus(es) configured to re-use the used product, control and/or monitoring data may be generated. The control and/or monitoring data may hence include at least one decentral identifier associated with the used product and/or at least one decentral identifier associated with at least one apparatus configured to re-use the used product. In addition to the matching, machine-readable instructions for processing the used product by one or more apparatus(es) configured to re-use the used product may be generated. Such instructions may relate multiple decentral identifiers associated with used products to at least one decentral identifier associated with at least one apparatus configured to re-use the used products. This way the products, may be digitally assigned to certain apparatuses depending on their properties at end-of-life. In other words, the methods may provide a second life or recycling recommender ensuring the used products end up in sensible reuse streams such as refurbishment, repurposing, recycling or the like.

In addition to the mere matching and finding the suitable reuse, the matching may further be re-fined by providing recyclate data related to one or more recyclate composition(s) to be refed into the production of the one or more producer(s) is collected. The control and/or monitoring data may be generated by correlating and/or relating the at least one physical and/or chemical property of the used product to recyclate data. The recyclate data may relate to recyclate flows as-sociated with recyclate producible via recycling of the used product or part(s) thereof. For example, recyclate data may be collected from one or more node(s) associated with one or more producer(s), such as chemical producer(s) or product producer(s). Recyclate data may relate to one or more recyclate composition(s) to be refed into the production of the one or more producer(s). Recyclate data may for a recyclate composition relate to a quantity of recyclate to be refed into the production of the one or more producer(s). The quantity may signify a demand for one or more recyclate composition(s). Based on material compositions data collected for multiple used products the recyclate composition to be produced from such used products may be determined.

The control and/or monitoring data may be generated by matching the production data related to one or more material composition(s) contained in the used product or part(s) thereof with recyclate data related to one or more recyclate composition(s) to be refed into the production of the one or more producer(s). Based on matching, control and/or monitoring data for producing the matching recyclate composition may be generated. The control and/or monitoring data may relate to used products for producing the recyclate e.g. demanded and/or to be refed into the production of the one or more producer(s) by way of decentral identifiers associated with the used products as provided by the reuse trigger. The control and/or monitoring data may include one or more decentral identifiers associated with used products for producing the recyclate e.g. demanded and/or to be refed into the production of the one or more producer(s). The control and/or monitoring data may include the machine-readable instructions for processing the used product.

The control and/or monitoring data and/or machine-readable instructions may further include instructions for treating the used product. The control and/or monitoring data and/or instruction may relate to repurposing of the used product. The control and/or monitoring data and/or instruction may relate to re-furbishing or second use of the used product. The control and/or monitoring data and/or instruction may relate to recycling of the used product.

The control and/or monitoring data may be configured to provide the used product or at least one part(s) thereof to a chemical and/or physical treatment plant associated with a producer, such as a chemical product producer or a product producer, or a recycler. The control and/or monitoring data may be associated with one or more process step(s) to reuse the used product. The control and/or monitoring data may relate to a chemical and/or physical treatment of the used product or part(s) thereof to recover the chemical material as recyclate. The control and/or monitoring data may relate to chemical and/or physical treatment method(s) suitable for treating the used product or part(s) thereof to produce recyclate. The control and/or monitoring data may be configured to initialize a process for re-using the at least one used product. The control and/or monitoring data may be provided to one or more node(s) of the decentral network, wherein the one or more node(s) may be associated with re-users for e.g. re-purpose, re-furbish, recycle and/or re-produce. The control and/or monitoring data may include specification of the re-use method, such as recycling method, to be produced recyclate, recycler identifier and/or chemical producer identifier related to chemical producer using recyclate as input material to produce new output material. Based on the generated control and/or monitoring data the process for reuse to e.g. re-purpose, re-furbish, recycle and/or re-produce the used product may be initialized and/or controlled.

The control and/or monitoring data to initiate re-use of used product may be provided to any node associated with participants of the decentral network. For example, the control and/or monitoring data may be provided to the node associated with the participant that triggered the re-use event or the control and/or monitoring data may be provided to the nodes associated with participants required to re-use the used product such as the refurbisher, the repuposer, the collector, the recycler and/or the producer re-using the used product or the recycled material.

The re-use trigger may include the product identifier, in particular a decentral identifier. The re-use trigger may include or relate to status data signifying the status of the used product. The status data associated with the product may relate to characteristics of the used product. The status data may relate to physical and/or chemical characteristics of the used product. The status data may include at least one chemical and/or physical property of the used product. The status data may include image data related to the condition of the used product.

Based on the decentral identifier provided by the re-use trigger product data associated with the used product may be collected from one or more participant node(s) of the decentral network. Product data may be retrieved from different nodes associated with participants of the product ecosystem e.g. the producer of the product or any user of the product. Product data may be as-sociated with the used product's history. Product data may include characteristics of the product. The product data may be collected from different nodes associated with participants of the product ecosystem. For example, monitoring data may be collected from node(s) associated with any participant of the product ecosystem or may be received with the re-use trigger. Pro-duction data may be collected from the node associated with the product producer. Further monitoring data related to the use of the product may be collected from node(s) associated with any participant of the product ecosystem or may be received with the re-use trigger.

For collection of production and/or monitoring data, the decentral product identifier may be used. The decentral product identifier may be linked to the decentral user identifiers or the decentral manufacturer identifiers. Such linking may be available to one or more participants of the product ecosystem. The decentral product identifier may be provided to a decentral database where the links between the decentral identifiers associated with the product, user and/or manufacturer may be stored. In another example the re-use trigger may include the linking information. Based on the decentral user identifier monitoring data may be retrieved. Based on the decentral manufacturer identifier production data may be retrieved.

For generation of control and/or monitoring data, the collected product data associated with the used product may be analyzed. The analysis may be based on the used product condition from status data, the product production data, the product monitoring data and/or recyclate data as-sociated with products. At least one physical and/or chemical property of the used product may be determined from the production and/or monitoring data collected via the at least one decentral identifier associated with the used product.

The physical and/or chemical property of the used product may relate to the physical and/or chemical product condition. Based on such conditions control and/or monitoring data may be generated. The physical and/or chemical property may signify a degradation state of the product such as damage or repair state, location/region, and/or the age of the used product. Based on such conditions control and/or monitoring data may be generated. The control and/or monitoring data may include the degradation state of the product such as damage or repair state, location/region, and/or the age of the used product. The control and/or monitoring data may include one or more apparatus(es) configured for re-use of the used product. The control and/or monitoring data may be provided to a node associated with the one or more apparatus(es) configured for re-use such as refurbish, repurpose and/or recycle.

Via such decision trees, control and/or monitoring data for recycling may be generated by correlating and/or relating at least one physical and/or chemical property of the used product to processing properties of one or more apparatus(es) configured for re-use of the used product. I and/or monitoring data for recycling may be generated.

The control and/or monitoring data may include machine-readable instructions for processing the used product including at least one decentral identifier associated with at least one apparatus configured to re-use the used product and at least one decentral identifier associated with the used product. The control and/or monitoring data may be associated with one or more process step(s) to reuse the used product. The control and/or monitoring data may relate to a chemical and/or physical treatment of the used product or part(s) thereof to recover the chemical material as recyclate.

The control and/or monitoring data may be configured to initialize a process for re-using the at least one used product. The control and/or monitoring data may be provided to one or more node(s) of the decentral network, wherein the one or more node(s) may be associated with re-users to e.g. re-purpose, re-furbish, recycle and/or re-produce the used product. The control and/or monitoring data may include a specification of the re-use method, such as recycling method, to be produced recyclate, recycler identifier and/or chemical producer identifier related to chemical producer using recyclate as input material to produce new output material. Based on the generated control and/or monitoring data the process for reuse to e.g. re-purpose, re-furbish, recycle and/or re-produce the used product may be initialized. Based on the generated control and/or monitoring data the process for reuse to e.g. re-purpose, re-furbish, recycle and/or re-produce the used product may be controlled and/or monitored. For example, the recycling process may be controlled and/or monitored according to the material composition signified by the control and/or monitoring data.

The decentral identifier may be uniquely associated with the used product and the product data including production and/or monitoring data. The decentral identifier may be related to an identifier element per product. The identifier element may include any physical arrangement that as-sociates the product identifier with the product or at least one component of the product. The identifier element may comprise a passive or active element, e.g. a number printed on the product, a QR-code, a RFID-tag, but is not limited thereto. The identifier element may be a physical identifier physically connected to the product or at least one component of the product. The identifier element may include markers embedded in materials, a product number, a bar code, a QR-Code, a tag like a RFID tag or similar physical arrangement that allows to digitally identify the product or at least one component of the product.

The identifier element may uniquely relate to the product. The identifier element may uniquely relate to the digital product identifier. The digital product identifier may uniquely relate to the product. This way product data may be provided per product or for individual products. The product identifier may relate to one or more decentral identifier(s) uniquely related to the product. The product identifier may relate to one or more decentral identifier(s) signifying the digital twin of the physical entity of the product. The decentral identifier may be a digital identifier of or for the decentral network. In other words the decentral identifier may uniquely identify the product for nodes of the decentral network. The decentral identifier may be a digital identifier provided to the decentral network and participant nodes of the decentral network. The decentral identifier may hence signify physical entities of products in the decentral network and participant nodes may be able to interpret the relation of the decentral identifier to the physical entities of products.

The decentral identifier may comprise any unique identifier uniquely associated with the data owner and article. The decentral identifier may include one or more Universally Unique Identifier(s) (UUID) or a Digital Identifier(s) (DID). The decentral identifier may be issued by a central or decentral identity issuer. The decentral identifier may include authentication information. Via the decentral identifier and its unique association with the data owner and product access to product data may be controlled by the data owner. This contrasts with central authority schemes, where identifiers are provided by such central authority and access to data is con-trolled by such central authority. Decentral in this context refers to the usage of the identifier as controlled by the data owner.

The decentral identifier may include one or more identifier(s) used in the decentral network and allowing for data exchange via the decentral network. Data exchange may include discovery of the decentral identifier for network nodes of the decentral network, authentication of network nodes of the decentral network and/or authorization of data transfers via a peer-to-peer communication between network nodes of the decentral network.

The decentral identifier may be uniquely associated with the product and product data relating to the production of the product and/or monitoring during use of the product. Through the unique association or relation of the decentral identifier and the product data associated with the product, the product data can be accessed by using the decentral identifier independent of the node storing product data or making product data accessible. This way the depth of the data accessible in the decentral network can be enhanced and used for processing the used product.

The re-use trigger may be generated on end-of-life event of the used product. The re-use trigger may include at least one decentral identifier and status data associated with the used product's state at end of life. Status data may include physical and/or chemical properties related to end-of-life such as degradation data associated with the product's degradation state at end-of-life or damage data associated with the product's damage state at end-of-life. The status data associated with the used product's state at end of life may be retrieved, collected or gathered based on the decentral identifier. The status data may be provided separately from the re-use trigger.

Product data relating to production of the used product and/or use of the used product may be collected via the at least one decentral identifier. Product data may include production data as-sociated with the production of the used product and/or monitoring data associated with the use of the used product. Physical and/or chemical properties of the product may be provided and or derivable from the product data. For example, the material composition of the used product may be provided by the production data. Further for example, the degradation state of the used product may be derivable or derived from the monitoring data. The degradation state may relate to the usage during lifetime of the product, the age, the number of repairs and/or the number of refurbishments.

Based on the gathered or collected data control and/or monitoring data may be generated. For generation the chemical and/or physical properties of the used product may be used to match to corresponding process properties of the apparatus(es) configured for re-use of the used product. The process properties of the apparatus(es) configured for re-use of the used product. may relate to chemical and/or physical properties of the used product. This way the suitable apparatus(es) configured for re-use of the used product may be selected based on the chemical and/or physical properties of the used product. The apparatus(es) configured for re-use of the used product may be associated with at least one decentral identifier digitally identifying the apparatus. Based on such matching machine-readable instructions for processing the used product by one or more apparatus(es) configured for re-use of the used product may be generated. The machine-readable instructions may include the decentral identifier associated with the used product and the decentral identifier associated with the apparatus(es) configured for re-use of the used product. The machine-readable instructions may relate locations of the used product and the apparatus(es) configured for re-use of the used product. The machine-readable instructions may specify the reuse method such as refurbish, repurpose or recycle. The machine-readable instructions may specify one or more process steps of the the reuse method such as refurbish, repurpose or recycle.

The control and/or monitoring data may include machine-readable instructions for processing the used product including at least one decentral identifier associated with at least one apparatus configured to re-use the used product and at least one decentral identifier associated with the used product. The machine-readable instructions may be associated with one or more process step(s) to reuse the used product. The machine-readable instructions may relate to a chemical and/or physical treatment of the used product or part(s) thereof to recover the chemical material as recyclate.

The machine-readable instructions may be configured to initialize a process for re-using the at least one used product. The machine-readable instructions may be provided to one or more node(s) of the decentral network, wherein the one or more node(s) may be associated with re-users to e.g. re-purpose, re-furbish, recycle and/or re-produce the used product. The machine-readable instructions may include a specification of the re-use method, such as repurpose method, purpose to be used and/or repurpose identifier associated with the entity performing repurpose, or recycling method, to be produced recyclate, recycler identifier and/or chemical producer identifier related to chemical producer using recyclate as input material to produce new output material. Based on the generated machine-readable instructions the process for re-use to e.g. re-purpose, re-furbish, recycle and/or re-produce the used product may be initialized. Based on the generated machine-readable instructions the process for reuse to e.g. re-purpose, re-furbish, recycle and/or re-produce the used product may be controlled and/or monitored. For example, the recycling process may be controlled and/or monitored according to the material composition signified by the generated machine-readable instructions.

### BRIEF DESCRIPTION OF THE DRAWINGS

In the following, the present disclosure is further described with reference to the enclosed figures.

FIG. 1 illustrates schematically an example of a tire as one possible example of a tire as an example product.

FIG. 2 illustrates schematically an example of material layers making up the tire in the tread area.

FIG. 3 illustrates an example of a tire ecosystem as one possible example of a product ecosystem.

FIG. 4 illustrate schematically an example of a method or apparatus for exchanging tire data between participants of the tire ecosystem as one possible example of a product ecosystem.

FIGS. 5a-c illustrate schematically examples of methods or apparatuses for providing data as-sociated with the production of tires, the use of tires and the handling of used tires across the tire ecosystem between participants connected via a decentral network.

FIG. 6 illustrates schematically a flowchart of a method for generating control and/or monitoring data associated with the re-use of used tires as an example of a used product.

FIG. 7 illustrates schematically an example of a method or apparatus for generating control and/or monitoring data associated with the re-use of used tires as an example of a used product.

FIG. 8 illustrate schematically an example of a method or apparatus for exchanging tire data and control and/or monitoring data associated with the re-use of used tires between participants of the tire ecosystem as an example product ecosystem.

FIG. 9 illustrates schematically a user interface for re-using used tires as an example of a used product.

### DETAILED DESCRIPTION

The following embodiments are mere examples for implementing the methods, the apparatuses, the systems, the decentral network services or applications disclosed herein and shall not be considered limiting.

The following description uses tires as example product. Other products may be handled in a similar manner and the example should not be considered limiting. Other products may include foam-based products, such as car seats, mattrasses or insulation panels, plastics-based products, such as packaging or car interiors, electronics devices, metal-based products, such as electrode active material of batteries.

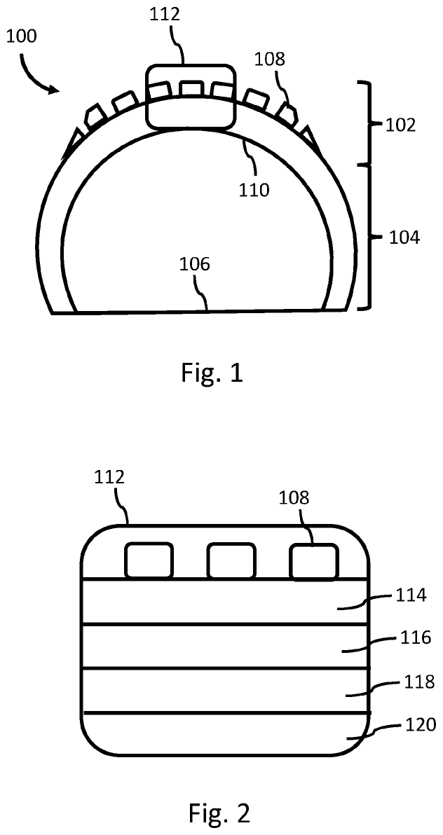

FIG. 1 illustrates schematically an example of a tire as one possible example of a tire as an example product.

The tire may be a tire for a vehicle. The vehicle may include an automobile such as a car, a van, a minivan, a bus, a SUV (sports utility vehicle); a truck; a lorry, a semitruck; a tractor; a motorcycle; a trailer; an ATV (all-terrain vehicle); a pickup truck; a heavy duty mover, such as bulldozer, mobile crane and earth mover; an airplanes; and other modes of transport that are commonly equipped with one or more tires

Tires for vehicles may be used for a limited amount of time. Tires are hence disposed regularly cumulating to considerable amounts of tire waste. The re-use rate of tires is still low since they are made of different materials that have to be separated.

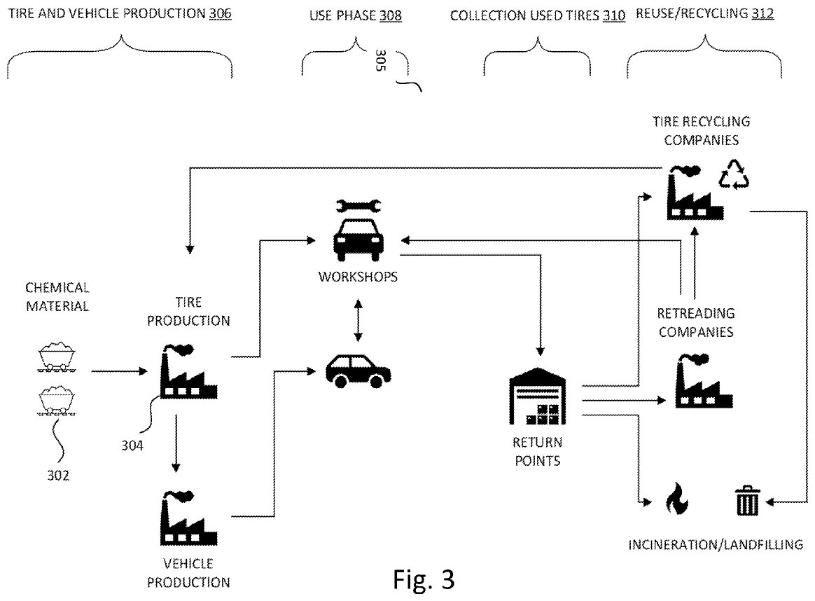

As illustrated schematically in FIG. 1, the tire 100 may comprise a tread section 102 and a side-wall section 104. The side wall section 104 may include beads that connect to the rim 106. The tread section 102 may include a layered structure 110 with different liners and the tread 108 as will be further described in FIG. 2.

One main material used in tires is rubber, such as natural or synthetic rubber. Another main material includes fillers such as carbon black or silica. Other materials include steel or textiles such as polyester, nylon, aramid or rayon cords. Further materials include chemical components such as antioxidants, sulfur, zinc oxide or antiozonants.

FIG. 2 illustrates schematically an example of material layers making up the tire in the tread area.

FIG. 2 illustrates the layered structure 112 of the tire as noted by reference sign 112 in FIG. 1.

The first layer 120 may include an inner liner of synthetic rubber. The second layer 118 may include a ply with fibre wires incorporated into rubber. The third layer 116 may include a casing ply with steel wires incorporated into rubber. The fourth layer 114 may include nylon wires incorporated into rubber. The outer most layer may include the tread 108 including rubber, carbon black and silica.

To re-use used tires different methods such as re-using with a different vehicle, regrooving, retreading or recycling may be applied. By recycling the recovery of rubber and fillers may be achieved. Such recycled materials may be used to produce new tires or other end products. This way the material from tires can be used multiple times and circularity of material flows may be achieved. However, existing collection and recycling chains are highly decentralized and only a small fraction of used tires is re-used or fed back into material flows. To improve the re-use rate of used tires and reduce environmental impact, the methods, apparatuses and systems proposed herein provide for more robust and efficient handling of used tires.

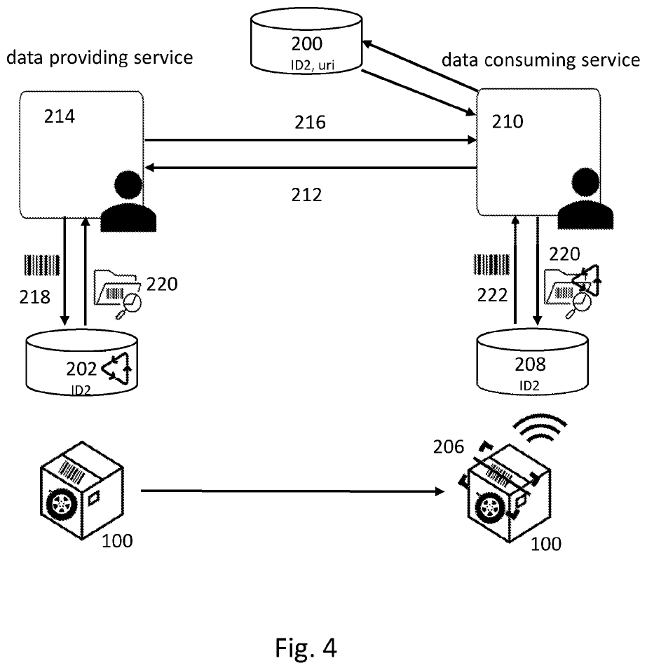

FIG. 3 illustrates an example of a tire ecosystem as one possible example of a product ecosystem.

The tire 100 may be a vehicle tire as described in the context of FIGS. 1 and 2. Section 306 of the tire ecosystem may relate to the production of tires 100.

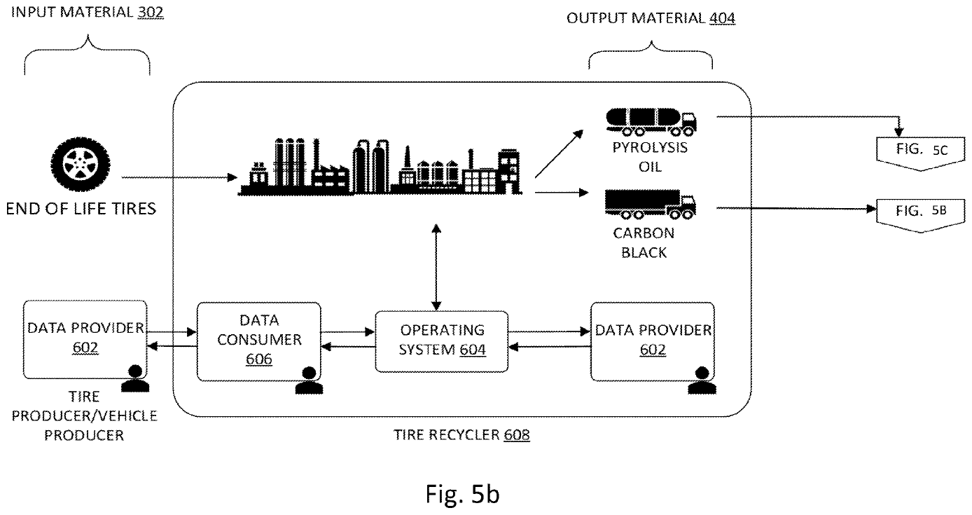

Tires may be produced by a tire producer via a tire production 304. The tires may be produced in one or more production steps. The tires may be produced from one or more chemical materials 302. Chemical materials 1302 may include, for example, chemical raw materials or intermediate chemical materials. Chemical raw materials may include water glass, and monomers used to produce rubber, such as butadiene, styrene and polyisobutene. Intermediate chemical materials may include rubber, such as natural rubber and/or synthetic rubber, steel, fillers (such as carbon black and silica), polymers, tackifiers, antioxidants, accelerators and antiozonants. Chemical materials 302 may be sourced from one or more chemical material suppliers, for example as described in the context of FIG. 5A.

The tires may comprise a tread section and a sidewall section as described in the context of FIGS. 1 and 2. The produced tires may be supplied from the tire production 304 to any participant using the tires in the use phase 305. The produced tires may be supplied from the tire pro-duction 304 to vehicle producers. The produced tires may be supplied from the tire production 304 to workshops. The produced tires may be supplied from the tire production 304 to tire dealers (not shown). The tire dealers may supply the tires to workshops and/or vehicle owners (not shown). Supply of the tires may be performed using one or more distribution centers (not shown). The vehicle producers may produce vehicles having attached the tires produced by tire production 304, e.g. having attached new tires. The produced vehicles may be provided to end users which may use the vehicle and hence the tires attached to the vehicle in the use phase 305.

The use phase 305 may include repair of tires. The use phase 305 may include exchange of a tires present on the vehicle. Repair of tires and/or exchange of tires may be performed by workshops. For instance, the workshop may exchange used tires (e.g. tires which can no longer be used on the vehicle) attached to a vehicle against new tires produced by tire production 304. For instance, the workshop may repair a flat tire to prolong the use of said tire.

The tire value chain may further include collection of used tires 310. Used tires may be collected at return points. The used tires may be provided to return points by workshops. The used tires may be provided to return points by tire dealers (not shown). The used tires may be collected from workshops and/or tire dealers and stored at the return points. The return points may be initial collection centers. The initial collection centers may provide the collected used tires to central return points. The return points may be central return points. At the return points, such as central return points, the received used tires may be inspected, and further handling may be determined. The used tires may be provided to tire recyclers, if they can no longer be used on vehicles. The used tires may be provided to retreading companies, if they can be retreaded. The used tires may be provided to regrooving companies (not shown), if they can be regrooved. The used tires may be provided to incineration facilities or disposed on landfills.

In view of the multiple options for re-using tires existing collection and recycling chains are highly decentralized and only a small fraction of used tires can be re-used or fed back into material flows. To improve the re-use rate of used tires and reduce environmental impact, the methods, apparatuses and systems proposed herein provide for more robust and efficient handling of used tires. In particular, connecting participants of the tire ecosystem via a decentral network allows for data sharing or exchange between participants of the decentral network to improve re-use of tires. Tires are only one example the methods, apparatuses and systems proposed herein may be applicable to. Other products can be handled in a similar way and the example of the tire as one possible product to be handled shall not be construed limiting.

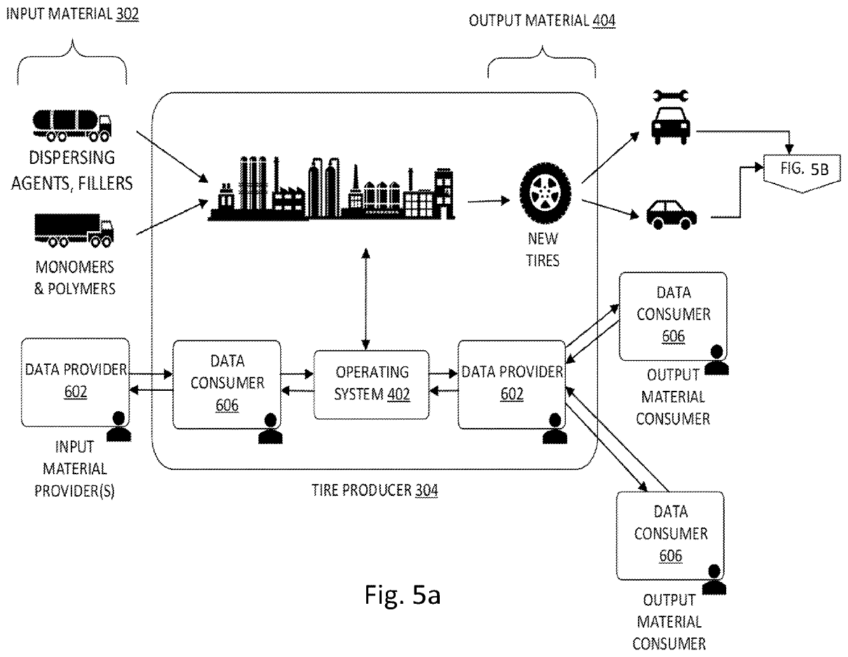

FIG. 4 illustrate schematically an example of a method or apparatus for exchanging tire data between participants of the tire ecosystem as one possible example of a product ecosystem.

The tire 110 as produced by a tire manufacturer may be provided in association with a tire passport. The tire passport may include a tire identifier. The tire identifier may include one or more decentral identifier(s). The decentral identifier may be an identifier in the decentral network allowing for data exchange via the decentral network. Data exchange may include discovery of the decentral identifier for participants of the decentral network, authentication of participants of the decentral network and/or authorization of data transfers via a peer-to-peer communication between participants of the decentral network. The tire passport may include data related to the tire. The tire passport may include a digital representation of the tire data associated with the tire 110.

The tire passport may further include or relate to authentication and/or authorization information linked to the tire identifier. The authentication and/or authorization information may be provided for authentication and/or authorization of a data providing service and/or data consuming service 210, 214. The tire identifier may include, may be or may relate to at least one decentral identifier, that is uniquely associated with the tire. The decentral identifier may be connected to the digital representation of the tire data associated with the tire 110. The digital representation may include a representation for accessing the tire data or parts thereof. The decentral identifier may include a Universally Unique IDentifier (UUID) or a Digital IDentifier (DID). The decentral identifier may include any unique identifier uniquely associated with a data owner and/or the tire. The data owner may be the producer of the tire. Via the decentral identifier and its unique association with the data owner and/or the tire access to the tire data may be controlled by the data owner.

The tire passport including the digital representation of tire data may be stored in a decentral data base 200. The tire data may be stored in a data base 202 associated with the data owner, such as the producer of the tire 304.

The tire 110 may be physically delivered to a user using the tire 110. The tire may be connected with an identification number encoding the tire identifier, in particular the decentral identifier. The user of the tire may read the identification number though an ID reader 206. The tire identifier may be provided to a data base 208 associated with the tire user. In other embodiments the tire user may retrieve the tire identifier through the decentral data base 200.

The data owner in this example may be the tire producer, any intermediate product producer producing an intermediate product for the tire or any producer producing a chemical product for producing the tire. The user of the tire, the workshop for tires, the recycler, collector or sorter of used tires may be data owner in the tire ecosystem. The data owner may comprise any entity generating data in the tire production chain. The data generating node may be coupled to the data owner or the entity owning or producing physical products from or for which data is generated. The data may be generated by a third-party entity on behalf of the entity owning physical products from or for which data is generated.

The data consuming service 210, 214 may comprise computer-executable instructions for accessing and/or processing data, such as tire data, associated with the data owner. The data providing service 210, 214 may comprise computer-executable instructions for providing and/or processing data, such as tire data, associated with the data owner for accessing and/or processing by the data consuming service 210, 214.

The tire identifier may be provided from the database 208 to the data consuming service 210 as signified by arrow 222. Based on the received tire identifier a request to access the tire data related to the tire identifier may be triggered by the data consuming service 210 as signified by arrow 212. The tire identifier may be provided to the data providing service 214 associated with or of the producer of the tire 304. In addition, authentication and/or authorization information may be provided. The request may be authenticated and/or authorized to access the tire data related to the tire identifier. Based on successful authorization and/or authentication access to the tire data related to the tier identifier may be granted.

For access the tire identifier may be provided to the data providing service 214 as signified by arrow 212. The data providing service 214 may use the received tire identifier to retrieve the tire data associated with the tire 304 as signified by arrows 218 and 221. The tire data associated with the tire provided to the data providing service 214 may be provided to the data consuming service 210 as signified by arrow 216. The tire data associated with the tire may be stored in the data base 208 associated with the user of the tire as signified by arrow 220.

Through the tire identifier, in particular the decentral identifier, the tire data can be uniquely as-sociated with the tire. Through the decentral network the tire data may be transferred between the producer of the tire and the user of the tire. This way the tire data can be shared with unique association to the tire and without central intermediary directly between the ecosystem players. This allows for transparency of tire data across the tire ecosystem.

Similarly, to the providing of tire data, re-use triggers, control and/or monitoring data and/or re-use instructions may be provided. Through the tire identifier, particularly the decentral identifier, the re-use triggers, control and/or monitoring data and/or re-use instructions may be uniquely associated with the used tire. Through the decentral network the re-use triggers, control and/or monitoring data and/or re-use instructions may be transferred between the participants of the tire ecosystem, such as the workshop, the recycler, the sorter and/or the collector. This way the re-use triggers, control and/or monitoring data and/or re-use instructions can be shared with unique association to the used tire and potentially without central intermediary directly between the participants of the decentral network. Such mechanism allows for more efficient recovery of materials used in tires and re-use e.g. via re-using, regrooving, retreading or material recycling. The digital backbone structure hence enables environmentally more friendly use of used tires and tire material. The digital backbone structure allows to reliably re-feed used tire materials into the production of new materials. This way the circular use of materials can be enhanced and broadened to diverse set of end products made of such materials. The digital backbone structure allows for reliably reusing used tires to reduce environmental impact of materials. This way the re-use of materials can be enhanced through digitally tracking materials, and it can be ensured waste products are treated in an environmentally friendly and effective manner.

FIGS. 5a-c illustrate schematically examples of methods or apparatuses for providing data associated with the production of tires, the use of tires and the handling of used tires across the tire ecosystem with participants connected via a decentral network.

FIG. 5a illustrates part of the tire ecosystem including the tire production 304 and the use of the produced tires 308, for example to manufactured vehicles. In this example, the input material provider, the tire producer and the tire consumer may be connected via a decentral network, for example as described in the context of FIG. 4. Data on input materials and produced tires may be provided via an ID based protocol described in the context of FIG. 4 in the form of passports associated with the physical entity of the input material, the tire or the vehicle having attached thereto the produced tires. The IDs associated with the different entities may be linked in such a way that the physical connection between the physical entities is reflected via digital links between the respective IDs. For example, the linked IDs associated with the physical entities may be provided via a decentral data base or registry of the decentral network. The participant nodes associated with participants of the tire network may retrieve such links or linked IDs associated with the physical links between the physical entities of the tire ecosystem. The IDs may include decentral identifiers for the decentral network.

The input material provider may provide the input material 302. The input material 302 may include raw materials or intermediate materials as described in the context of FIGS. 1 to 3, such as dispersing agents, fillers, monomers and polymers. The input material data of said input material 302 may be provided through data provider(s) (also called data providing service(s) or node associated with input material provider) 602 associated with the input material provider(s) connected to the decentral network as for example described in the context of FIG. 4.

The tire producer may produce the tire(s) 404 from the input material(s) 302 provided to the tire production as for example as described in the context of FIGS. 1 to 4. The tire producer may access the input material data associated with the input material 302 through a data consumer (also called data consuming service or node associated with tire producer) 606 connected to the decentral network as for example as described in the context of FIG. 4. Said input material data may be retrieved from data provider(s) 602 associated with the respective input material provider(s) as for example as described in the context of FIG. 4. The tire producer may generate the tire passport associated with the produced tire 404 as for example as described in the context of FIG. 4. The tire producer may provide the tire passport and tire data via said passport through data provider 602 connected to the decentral network as for example as described in the context of FIG. 4. The tire consumer, such as the vehicle manufacturer or the workshop, may access the tire data associated with the produced tire 404 or a part(s) thereof through data consumer 606 connected to the decentral network as for example as described in the context of FIG. 4.

The respective data owners in this example may be the input material producer, the tire producer, and the tire consumer. The data owner may comprise any entity generating data. The data generating node may be coupled to the data owner or the entity owning or producing physical products from or for which data is generated. The data may be generated by a third-party entity on behalf of the entity owning physical products from or for which data is generated.

In the example of FIG. 5a, the decentral identifier of the tire passport may relate to the tire. Such decentral identifier may be provided to nodes associated with ecosystem participants. Via the tire specific decentral identifier, data associated with the tire may be gathered across nodes as-sociated with the ecosystem participants including for example the production chain participants or participants using the tire assigned to tire specific decentral identifier. For example, one or more environmental attribute(s) associated with the tire may be derived from the environmental attribute(s) associated with the input material 302 or any other product entity present in the value chain of the tire. Tire data gathered during production may include static or dynamic properties of the tire. The tire data may relate to or include properties of the chemical material(s) used to produce the tire. Data associated with the tire may be gathered during the use of the tire attached to the vehicle. For instance, such use data may be gathered by workshops or by sensors associated with the tire or the car the tire is attached to. The decentral identifier associated with the tire may be used to access tire data generated during use of the tire, such as lifetime data or repair data. Use data may include data related to the use of the tire, such as driven distance, average life time, type of vehicle the tire is attached to, manufacturer of the vehicle the tire is attached to, wear of the tire, current weight of the tire, repair data and/or weather conditions.

This way, the tire data may signify a digital twin of the tire, including the production history of the tire and/or the use history of the tire. Gathering data related to the use of the tire allows to up-date the digital twin of the tire such that it reflects the use history of the tire. Data on the components used to produce the tire and data on the use of the tire may be used by the return points, retreading companies and/or recyclers to determine appropriate handling of used tires based on said data. For instance, the tire recycler (see for example FIG. 5b) may determine appropriate recycling operations based on said data.

As described in the context of FIG. 3, used tires may be provided to tire recyclers. The used tires may correspond to input material 302 for the tire recyclers 608 as illustrated in FIG. 5b. The tire data of said used tires 302 may be provided through data provider(s) 602 associated with the tire producers and/or vehicle manufacturers via the decentral network as for example described in the context of FIG. 4. The tire recycler 608 may recycle the used tire(s) provided to the tire recycler, for example as described in the context of FIG. 3. The tire recycler may access the tire data associated with the used tires 302 through a data consumer (also called data consuming service) 606 via the decentral network as for example described in the context of FIG. 4.

Said tire data may be retrieved from data provider(s) 602 associated with the tire producer and/or the vehicle manufacturer. The tire recycler may generate a recycled product passport as-sociated with the product obtained from recycling, such as pyrolysis oil or carbon black 404. Pyrolysis oil may be formed upon pyrolysis of shredded tires, for example as described in the FIG. 3. The tire recycler may generate a pyrolysis oil passport including the composition data of the pyrolysis oil. Pyrolysis oil composition data may signify a mixture of saturated and unsaturated hydrocarbons having from 5 to 46 carbon atoms. The hydrocarbons may be saturated or un-saturated. Unsaturated hydrocarbons may include aromatic hydrocarbons. Examples of aromatic hydrocarbons may include mono-, di- and triaromatic compounds and polycyclic aromatic compounds. Examples of non-aromatic compounds may include paraffins, mono-naphthenes, di napthenes and cycloalkanes. The pyrolysis oil composition data may signify up to 30 wt. % of hydrocarbons having from 5 to 10 carbon atoms, up to 60 wt. % of hydrocarbons having from 11 to 20 carbon atoms, up to 10 wt.-% of hydrocarbons having from 21 to 30 carbon atoms and less than 10 wt.-% of hydrocarbons having from 31 to 46 carbon atoms.

The tire recycler 608 may provide the recycled product data or parts thereof contained in the re-cycled product passport through data provider 602 connected to the decentral network for example in accordance with the protocol as described in the context of FIG. 4. The respective data owners in this example may be the tire producer 304 and/or vehicle manufacturer, and the tire recycler 608.

In the example of FIG. 5b, the decentral identifier may relate to the recycled product. Such decentral identifier may be provided to the tire ecosystem participants. Via said decentral identifier, data associated with the recycling of the tire may be gathered and assigned to said decentral identifier. The decentral identifier may relate to the tire specific decentral identifier. This way, data on the tire which was used to produce the recycled product may be derived from the decentral identifier contained in the recycled product passport. For instance, the recycled material passport may contain the decentral identifier included in the tire passport as well as data on the relationship between the decentral tire identifier and the decentral identifier included in the recycled material passport.

Products obtained from recycling tires, such as carbon black, may be provided to tire producers 304 and may be used as input materials 302 to produce new tires (see for example FIG. 3). Data on such products may be retrieved by tire producer 304 via a data consumer 606 from data provider 602 associated with tire recycler 608 as for example described in the context of FIG. 4. The input material provider for tire producer 304 may correspond to raw material supplier(s), intermediate product producer(s) or tire recycler(s).

Products obtained from recycling tires, such as pyrolysis oil, may be provided to chemical producers producing chemical materials, such as raw materials and intermediate products, using the pyrolysis oil as input material 302. Hence, the pyrolysis oil produced by tire recycler 608 may correspond to input material 302 of a chemical material producer operating a chemical pro-duction network 610, for example as illustrated in FIG. 5c. The pyrolysis oil data of said pyrolysis oil 302 may be provided through data provider(s) 602 associated with the tire recycler 608 connected to the decentral network as for example described in the context of FIG. 4. The chemical production network 610 may produce one or more raw materials and/or intermediate products 404, for example the raw materials and intermediate products described in the context of FIG. 3. Examples of raw materials include monomers used to prepare synthetic rubber. Examples of intermediate products include dispersing agents, fillers and polymers, such as synthetic rubber. The chemical producer operating the chemical production network 610 may access the pyrolysis data associated with the pyrolysis oil 302 through data consumer 606 connected to the decentral network as for example described in the context of FIG. 4. Said pyrolysis oil data may be retrieved from data provider 602 associated with the tire recycler 608. The chemical producer may generate chemical product passports associated with the produced chemical products, such as monomers, polymers, fillers and dispersing agents. The chemical producer may provide the chemical product data or parts thereof contained in the chemical product passport through data provider 602 connected to the decentral network as for example described in the context of FIG. 4. The chemical product data may contain environmental attributes associated with the chemical product, such as recycled content from the use of pyrolysis oil obtained from recycled tires. The respective data owners in this example may be the tire recycler 608 and the chemical producer operating chemical production network 610.

In the example of FIG. 5c, the decentral identifier may relate to the chemical product. Such decentral identifier may be provided to the value chain participants. Via said decentral identifier, data associated with the produced chemical product may be gathered and assigned to said decentral identifier. The decentral identifier may relate to the pyrolysis oil specific decentral identifier and/or the tire specific decentral identifier. This way, data on the tire which was indirectly used to produce the chemical product may be derived from the decentral identifier contained in the chemical product passport. Moreover, environmental attributes associated with the pyrolysis oil may be derived from the decentral identifier contained in the recycled material passport as-sociated with the pyrolysis oil produced by tire recycler 608.

The chemical products produced by chemical production network 610 may be provided as input materials 302 to tire production 304, as for example illustrated in FIG. 5a. Tire producer 304 may retrieve chemical product data provided by data consumer 606 associated with chemical pro-duction network 610 via data consumer 606 as described in the context of FIG. 4. The decentral identifier of the chemical product passport may be related with the decentral identifier of the tire passport associated with the tire produced from the chemical product. This way, environmental attributes of chemical products and tires produced from said chemical products 302 may be tracked through the value chain up to the tire. By tracking the environmental attributes of tires in such way, the information can be made transparent across the tire ecosystem while the information flow can be controlled by the participants of the tire ecosystem. In addition, the environmental attributes can be handled according to the individual participants needs by pro-duction operating systems. Overall, such tracking enables tracking of positive environmental impact by individual tire value chain participants, which makes positive environmental impacts transparent and attributable to individual tire value chain participants.

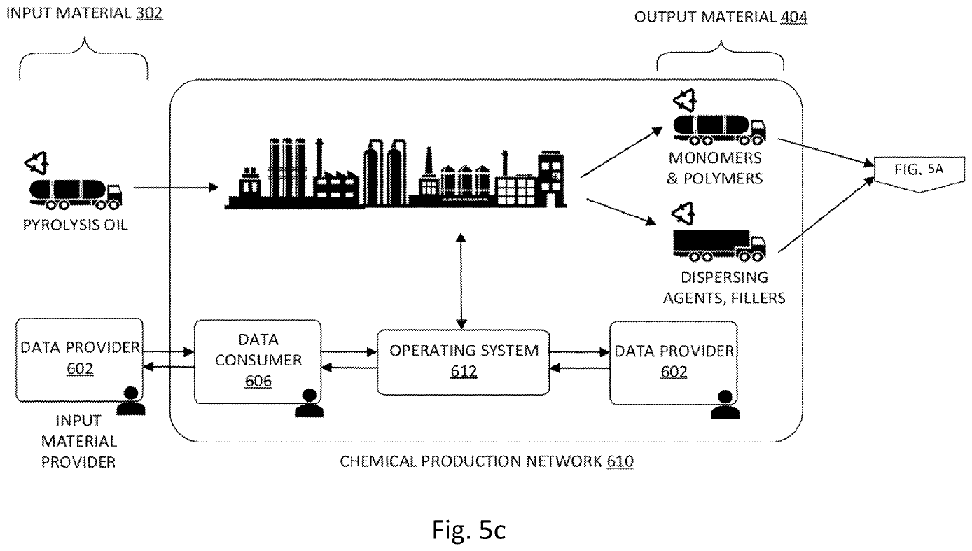

FIG. 6 illustrates schematically a flowchart of a method for generating control and/or monitoring data associated with the re-use of used products such as tires as an example of a used product. In the example tires will be used for illustrative purposes only and is similarly applicable to other used products such as batteries.

The re-use trigger may be generated by a node associated with the participants of the tire ecosystem. The participant may be a workshop repairing or exchanging tires for vehicles or a collector for used tires. For generation of the re-use trigger, the identification of the tire may be read through an ID reader or may be manually entered into an application such as a mobile app. The tire may reach its re-use stage when the tread is worn down e.g. below 4 mm or when the tire has a defect that cannot be repaired.

Based on providing the tire identification the decentral identifier associated with the used tire may be retrieved via the decentral network. For example, the tire identification may be provided to a decentral data base or a decentral registry storing the decentral identifiers in connection with the tire identification. The decentral database may be a data base including decentral identifiers for tires in the tire ecosystem. The decentral database may include a distributed ledger and may allow for verification of the tire identifier. Further for example, the decentral identifier may be retrieved from a registry storing the decentral identifiers in connection with the tire identification and associated with the participant triggering the re-use trigger. Further for example, the decentral identifier may be fetched from a registry associated with any participant in the tire ecosystem, such as the tire producer or the tire user. The participant triggering the re-use event may connect via authentication and/or authorization protocols of the decentral network to nodes associated with other participants of the tire ecosystem as for example described in the context of FIG. 4 or 5.

The re-use trigger may include the decentral identifier associated with the tire and status data associated with the used tire. The status data may include characteristics of the used tire such as the tread depth of the tire or defects of the tire declaring end-of-life. Visual inspection data such as image data as for example provided from smart phone camera.

The re-use trigger including the decentral identifier associated with the used tire may be provided to any node associated with a participant of the tire ecosystem collecting tires. For example, the re-use trigger may be provided to the node associated with the tire producer, the chemical producer supplying the tire production chain or the recycler. The re-use trigger may be sent to the node associated with the respective participant.

Based on the providing of the re-use trigger control and/or monitoring data associated with the re-use of the used tire may be generated. To generate control and/or monitoring data further data in particular relating to at least one physical and/or chemical property of the used tire may be retrieved from nodes associated with different participants of the tire ecosystem. For example, tire production data including composition data associated with the materials making up the used tire may be retrieved from the producer of the tire. Further for example, tire use data including repair data associated with the tire during its use may be retrieved from nodes associated with workshops or workshop data associated with the car the tire was used with may be retrieved from nodes associated with workshops. Further for example, tire use data including lifetime data associated with the tire may be retrieved from the car the tire was used with. Further for example, sensor data associated with a measured property of the used tire may be retrieved from any node e.g. associated with workshops or collectors. This way physical and/or chemical properties of the used tire may be collected. The physical and/or chemical properties may be measured properties of the used tire such as image or IR sensor data. The physical and/or chemical properties may be determined from tire data collected via the at least one decentral identifier associated with the used tire, such as the composition data or use data related to repairs, retreading, regrooving or the like.

The control and/or monitoring data may be generated by correlating and/or relating the at least one physical and/or chemical property of the used tire to processing properties of one or more apparatus(es) configured to re-use the used tire and/or by generating machine-readable instructions for processing the used tire by one or more apparatus(es) configured to re-use the used tire. Processing properties may relate to the re-use process performed by the apparatus. In dependence of the provided physical and/or chemical property, the processing properties required for re-use and with that the suitable apparatus(es) configured to re-use the used tire may be determined. Apparatus(es) configured for re-use the used product, process the used product by re-purposing, refurbishing or recycling the used product.

The processing properties of the one or more apparatus(es) configured to re-purpose or refurbish the used product may depend on physical properties such as tread depth. The physical property such as tread depth may be provided through measurement such as one or more images of the tire showing the tread. The tread depth may be reconstructed from one or more images of the tire by way of image analysis e.g. including object detection or reconstruction. The physical property such tread depth may be provided through measurement such as depth measurement via IR sensor or other distance sensitive sensors.

The processing properties of the one or more apparatus(es) configured to recycle the used product may relate at least to one chemical property of the used product. The chemical property such as tire composition or content of specific components of the tire such as carbon black may be provided through the peer-to-peer communication network upon request and data transfer between nodes of the decentral network.

The processing properties of the one or more apparatus(es) that are being matched with the physical and/or chemical properties of the used product may be stored in a central or decentral data base or storage. The processing properties may be collected from one or more network node(s) associated with product re-users connected via a decentral network. The network node the processing properties of one or more apparatus(es) are to be collected from may be selected based on at least one property provided for the used product. For example, if the tread as provided by sensor measurement indicates less than 4 mm and the re-treading status as provided by workshop indicates already retreaded, the node provided with the re-use trigger may gather processing properties of the one or more apparatus(es) configured for re-use e.g. by recycling and match with the physical and/or chemical properties of the used tire. Suitable apparatus(es) configured for re-use may be selected based on such matching. This way by correlating and/or relating the at least one physical and/or chemical property of the used tire to processing properties of one or more apparatus(es) configured to re-use the used product, control and/or monitoring data may be generated. The control and/or monitoring data may hence include at least one decentral identifier associated with the used tire and/or at least one decentral identifier associated with at least one apparatus configured to re-use the used tire. In addition to the matching machine-readable instructions for processing the used tire by one or more apparatus(es) configured to re-use the used tire may be generated. Such instructions may relate multiple decentral identifiers associated with used tires to at least one decentral identifier associated with at least one apparatus configured to re-use the used tires. This way the tires, may be digitally assigned to certain apparatuses depending on their properties at end-of-life. In other words, the methods may provide a second life or recycling recommender ensuring the used tires end up in sensible reuse streams such as refurbishment, retreading, recycling or the like.

In addition to the mere matching and finding the suitable reuse, the matching may further be refined by providing recyclate data related to one or more recyclate composition(s) to be refed into the production of the one or more producer(s) is collected. The control and/or monitoring data may be generated by correlating and/or relating the at least one physical and/or chemical property of the used product to recyclate data. The recyclate data may relate to recyclate flows as-sociated with recyclate producible via recycling of the used product or part(s) thereof. For example, recyclate data may be collected from one or more node(s) associated with one or more producer(s), such as chemical producer(s) or product producer(s). Recyclate data may relate to one or more recyclate composition(s) to be refed into the production of the one or more producer(s). Recyclate data may for a recyclate composition relate to a quantity of recyclate to be refed into the production of the one or more producer(s). The quantity may signify a demand for one or more recyclate composition(s). Based on material compositions data collected for multiple used products the recyclate composition to be produced from such used products may be determined.

The control and/or monitoring data may be generated by matching the production data related to one or more material composition(s) contained in the used product or part(s) thereof with recyclate data related to one or more recyclate composition(s) to be refed into the production of the one or more producer(s). Based on matching, control and/or monitoring data for producing the matching recyclate composition may be generated. The control and/or monitoring data may relate to used products for producing the recyclate e.g. demanded and/or to be refed into the production of the one or more producer(s) by way of decentral identifiers associated with the used products as provided by the reuse trigger. The control and/or monitoring data may include one or more decentral identifiers associated with used products for producing the recyclate e.g. demanded and/or to be refed into the production of the one or more producer(s). The control and/or monitoring data may include the machine-readable instructions for processing the used product.

The control and/or monitoring data and/or machine-readable instructions may further include instructions for treating the used product. The control and/or monitoring data and/or instruction may relate to repurposing of the used product. The control and/or monitoring data and/or instruction may relate to re-furbishing or second use of the used product. The control and/or monitoring data and/or instruction may relate to recycling of the used product.

The control and/or monitoring data may be configured to provide the used product or at least one part(s) thereof to a chemical and/or physical treatment plant associated with a producer, such as a chemical product producer or a product producer, or a recycler. The control and/or monitoring data may be associated with one or more process step(s) to reuse the used product. The control and/or monitoring data may relate to a chemical and/or physical treatment of the used product or part(s) thereof to recover the chemical material as recyclate. The control and/or monitoring data may relate to chemical and/or physical treatment method(s) suitable for treating the used product or part(s) thereof to produce recyclate. The control and/or monitoring data may be configured to initialize a process for re-using the at least one used product. The control and/or monitoring data may be provided to one or more node(s) of the decentral network, wherein the one or more node(s) may be associated with re-users for e.g. re-purpose, re-furbish, recycle and/or re-produce. The control and/or monitoring data may include specification of the re-use method, such as recycling method, to be produced recyclate, recycler identifier and/or chemical producer identifier related to chemical producer using recyclate as input material to produce new output material. Based on the generated control and/or monitoring data the process for reuse to e.g. re-purpose, re-furbish, recycle and/or re-produce the used product may be initialized and/or controlled.

The control and/or monitoring data to initiate re-use of used tire may be provided to any node associated with participants of the decentral network. For example, the control and/or monitoring data may be provided to the node associated with the participant that triggered the re-use event or the control and/or monitoring data may be provided to the nodes associated with participants required to re-use the used tire such as the retreader, the regroover, the collector, the recycler and/or the producer re-using the used tire or the recycled material.

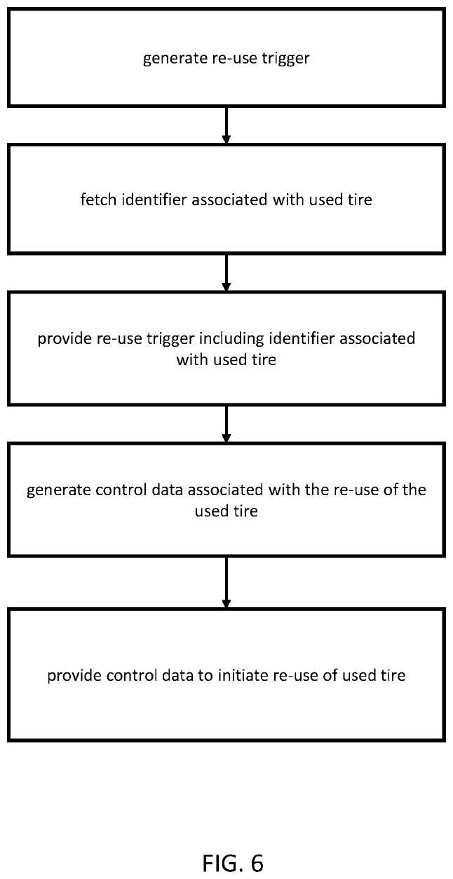

FIG. 7 illustrates schematically an example of a method or apparatus for generating control and/or monitoring data associated with the re-use of used tires and for controlling and/or monitoring treatment of used tires as an example of a used product.

A re-use trigger may be generated and provided as described in the context of FIG. 6. The re-use trigger may for instance be generated by the re-use trigger generator node 802 e.g. associated with the workshop participant or the user of the tire. The re-use trigger may be associated with the tire. The re-use trigger may include the tire identifier. The re-use trigger may include or relate to status data signifying the status of the used tire. The status data associated with the tire may relate to characteristics of the used tire. The status data may relate to physical and/or chemical characteristics of the used tire. The status data may include at least one chemical and/or physical property of the used tire. The status data may include image data related to the condition of the used tire. The image may be analyzed via an image algorithm to provide the status data such as tread depth or tread condition. The status data may include near-infrared data. The near infrared data may be analyzed to provide status data such as at least part of the material composition of the used tire or material condition of the used tire. The status data may relate to the tread depth of the used tire, age of the used tire, damage or repair status of the used tire, tread condition of the used tire, parts of the material composition of the used tire, material condition of the used tire or combinations thereof.

Based on the re-use trigger control and/or monitoring data associated with the re-use of the tire may be generated by a control data generator node 804. Based on the decentral identifier provided by the re-use trigger tire data associated with the tire may be collected from one or more participant node(s) of the decentral network e.g. by a tire data collector. Tire data may be retrieved from different nodes associated with participants of the tire ecosystem e.g. the producer of the tire or any user of the tire. Tire data may be associated with the used tire's history. Tire data may include characteristics of the tire such as original tread depth, tire type, production date of the tire, material composition of the tire, re-treading status of the tire, repair status of the tire, origin of the tire or combinations thereof. The tire data may be collected from different nodes associated with participants of the tire ecosystem. For example, monitoring data such as tread depth of the used tire, re-treading status and/or repair status may be collected from the node associated with the workshop participant or may be part of the re-use trigger. Production data such as tire type, tire age, material composition of the tire or parts thereof, origin of the tire may be collected from the node associated with the tire producer. Further monitoring data related to the use of the tire in connection with the vehicle may be collected from the node associated with the vehicle or the vehicle manufacturer participating in the tire ecosystem.

For collection of production and/or monitoring data, the decentral tire identifier may be used. The decentral tire identifier may be linked to the decentral vehicle identifier or the decentral manufacturer identifier. Such linking may be available to one or more participants of the tire ecosystem. For example, if the monitoring data of the tire during its use with the vehicle may be collected, the decentral tire identifier may be provided to a decentral database where the links between the decentral identifiers associated with the tire and the vehicle may be stored. In another example the re-use trigger may include the linking information to the vehicle. Based on the decentral vehicle identifier monitoring data may be retrieved.

For generation of control and/or monitoring data, the collected tire data associated with the used tire may be analyzed e.g. by tire data analyzer. The analysis may be based on the used tire condition from status data, the tire production data, the tire monitoring data and/or recyclate data associated with tires. At least one physical and/or chemical property of the used tire may be determined from the production and/or monitoring data collected via the at least one decentral identifier associated with the used tire.

The physical and/or chemical property of the used tire may relate to the physical and/or chemical tire condition. Based on such conditions control and/or monitoring data may be generated, e.g. by control data provider. The physical and/or chemical property may signify the wear of the tire including the tread depth, the current tread wear condition, the damage or repair condition, the contamination status, re-grooving or re-treading condition, location/region, size and the age of the used tire. Re-grooving or re-treading conditions may be determined based on the decentral identifier of the tire and tire data associated to it.

If the tread depth exceeds a minimum threshold of e.g. 4 mm, the tread wear is signified as even e.g. via image recognition, the damage or repair condition is signified as no damage or repair and the age is signified below a minimum threshold such as less than 6 years, control and/or monitoring data for re-purposing the tire may be generated. Such control and/or monitoring data may include the tread depth of the used tire and the decentral identifier of the used tire. The control and/or monitoring data may be provided to a node for repurposing 806, e.g. associated with the tire dealer for selling the used tire.

If the tread depth exceeds a minimum threshold e.g. less than 4 mm, the re-grooving condition signifies no regrooving, and the age is signified below a minimum threshold such as less than 6 years, control and/or monitoring data for re-grooving may be generated. Such control and/or monitoring data may include the tread depth to be re-grooved and the decentral identifier of the used tire. The control and/or monitoring data may be provided to a node for regrooving 808, e.g. associated with the re-groover.

If the tread depth does not exceed a minimum threshold e.g. less than 4 mm, the repair, damage, re-treading condition signifies no damage, repair, retreading, the material composition allows for re-treading and the age is signified below a minimum threshold such as less than 6 years, control and/or monitoring data for re-treading may be generated. Such control and/or monitoring data may include at least parts of the material composition of the tire and the decentral identifier of the used tire. The control and/or monitoring data may be provided to a node for retreading 810, e.g. associated with the re-treader.

If the tread depth does not exceed a minimum threshold e.g. less than 4 mm and is still above a lower limit such as 3 mm, the damage, repair, re-grooving or re-treading condition signifies any of the conditions true or the age is signified above a minimum threshold such as more than 6 years, control and/or monitoring data for recycling may be generated. Such control and/or monitoring data may include at least parts of the material composition of the tire and the decentral identifier of the used tire. The control and/or monitoring data may be provided to a node for recycling 812, e.g. associated with one or more participant(s) of the recycling chain or one or more recycler(s).

Via such decision trees, control and/or monitoring data for recycling may be generated by correlating and/or relating at least one physical and/or chemical property of the used tire to processing properties of one or more apparatus(es) configured to re-use the used tire. In case of re-purposing the tread depth as physical property may be correlated and/or related to the minimum tread depth for re-purposing apparatuses. In case of re-treading the tread depth and the material composition as physical and chemical properties may be correlated and/or related to the minimum tread depth and suitable material compositions for re-treading apparatuses. In case of recycling the material composition as chemical property may be correlated and/or related to the suitable material compositions for recycling apparatuses.

In particular, the used tire composition or parts thereof may be provided to the node associated with the recycler. The material composition may signify the tire composition including PET, PA6, PA6.6., steel, synthetic rubber, natural rubber or combinations thereof. The decentral identifier of the used tire may be linked to the decentral identifier(s) associated with one or more apparatuses for recycling. The assignment of the decentral identifier of the used tire linked to the decentral identifier(s) associated with one or more apparatuses for recycling may be based on the material configuration of the tire. For example, tires with PET fibres may be assigned separately from tires with PA6 fibres. The apparatus(es) for recycling may include mechanical recycling apparatuses, chemical recycling apparatuses such as pyrolysis or devulcanization apparatuses. For example, the used tire may be provided to the mechanical recycling apparatuses to separate PET, PA6.6. or PA 6 or steel tire cords. The remaining fraction may be provided to chemical recycling apparatuses to recover silica, carbon black and/or rubber. In other embodiment the used tire may be shredded or the remaining fraction after separation of tire cords may be provided to the apparatus for re-purposing the shredded tire. Recycling may include shredding of used tires. The shredded tires may be used for different applications depending on their size. For instance, rough shreds with sizes of 50 -250 mm may be used as drainage material and alternative to natural gravel. Fine shreds with sizes of 15-50mm may be used as bases in ground beds for water purification and as an alternative for natural gravel. Granulates with grain sizes up to 6 mm may be used in rubber asphalt, foundry-tails or as infill for artificial turf. Powder may be blended into paint for sound attenuation or used as a sub-component in the manufacture of new tires and other molded products.

Further to the physical and/or chemical property of the tire, recyclate data relating to recyclate flow to be refed into production of the one or more producer(s) may be collected e.g. from nodes associated with chemical producers. If recyclate flow associated with recyclable components of the used tire are required to produce new materials, control and/or monitoring data for recycling may be generated.

The control and/or monitoring data may include machine-readable instructions for processing the used tire including at least one decentral identifier associated with at least one apparatus configured to re-use the used tire and at least one decentral identifier associated with the used tire. The control and/or monitoring data may be associated with one or more process step(s) to reuse the used tire. The control and/or monitoring data may relate to a chemical and/or physical treatment of the used tire or part(s) thereof to recover the chemical material as recyclate.

The control and/or monitoring data may be configured to initialize a process for re-using the at least one used tire. The control and/or monitoring data may be provided to one or more node(s) of the decentral network, wherein the one or more node(s) may be associated with re-users to e.g. re-purpose, re-furbish, recycle and/or re-produce the used tire. The control and/or monitoring data may include a specification of the re-use method, such as recycling method, to be produced recyclate, recycler identifier and/or chemical producer identifier related to chemical producer using recyclate as input material to produce new output material. Based on the generated control and/or monitoring data the process for reuse to e.g. re-purpose, re-furbish, recycle and/or re-produce the used tire may be initialized. Based on the generated control and/or monitoring data the process for reuse to e.g. re-purpose, re-furbish, recycle and/or re-produce the used tire may be controlled and/or monitored. For example, the recycling process may be con-trolled and/or monitored according to the material composition signified by the control and/or monitoring data.

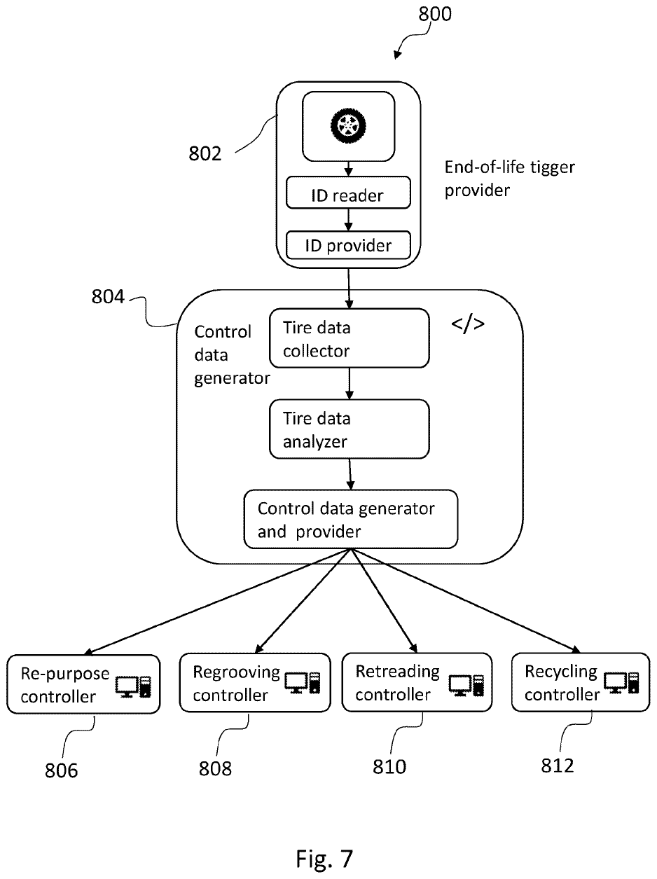

FIG. 8 illustrates schematically an example of a method or apparatus for exchanging tire data and control and/or monitoring data associated with the re-use of used tires between participants of the tire ecosystem as an example product ecosystem.

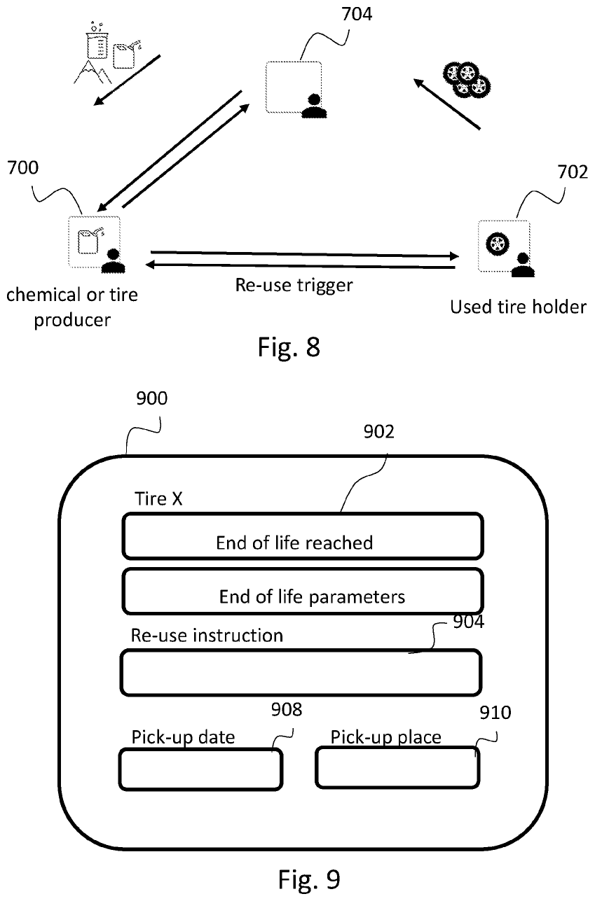

In the examples the re-use trigger may be provided to node associated with chemical producer 700. The node associated with the chemical producer may generate control and/or monitoring data. Such control and/or monitoring data may be provided to the node associated with used tire holder 702 and used to recycle the used tire. FIG. 9 illustrates schematically a user interface for re-using used tires as it may be provided to the used tire holder 702. The user interface 900 may display information on the tire such as the indication end-of-life reached and end-of-life parameters 902. The user interface 900 may display reuse instruction 904 such as to be recycled.

The user interface 900 may display pick-up date 908 and place 910 to inform the used tire holder 702 of the next steps.

The used tires may be transported to used tire recycler 704 for mechanical and/or chemical recycling, such as pyrolysis of the used tire or at least part(s) thereof. Recycling may include devulcanization of used tires. The devulcanization may be performed by a tire recycling company. Devulcanization may be performed using the tread of the used tires. Devulcanization may be performed using mechanical, microwave, chemical or biological processes to break sulphur bonds formed during vulcanization. The recycled material may be mixed into new tires and other rubber products which may be used for sound, vibration and shock absorption. Recycling may include pyrolysis of used tires. The pyrolysis may be performed in a tire recycling company. The used tires may be shred and heated in an oxygen free atmosphere.

Products resulting from pyrolysis may include oil, steel and non-condensable gases. From a single tire, approximately ⅓ of the weight is steel, ⅓ becomes pyro black (carbon black plus additives) and the final ⅓ is oil/gas. A tire pyrolysis system may include an indirectly fired rotary kiln, steel recovery, char handling, grinding and pelletizing circuit, oil condensing system and gas cleaning system.

The recycling product such as pyrolysis oil or PA6 may be provided to chemical producer 700 for the production of new materials. The used tire recycler may provide recycled material data relating to the composition of the recycled material to the chemical producer 700. Part of the re-cycled material may be re-used to produce new tires. For instance, the carbon black obtained from pyrolysis, and/or the material obtained from devulcanization may be provided to tire pro-duction 304.

By processing used products such as tire as proposed, the material used for such products can be effectively re-used. This decreases the environmental impact of material flows by re-using the products through second uses until the used product is not reusable through second uses anymore. Once such end-of-life situation is reached the materials used for such products can be recycled and refed as recycled material into the production of new products. By processing used products in a data driven manner based on their physical and/or chemical properties through decentral peer-to-peer network, re-use can be controlled in an effective manner and more used products can be re-used, thus increasing the number of re-used products and de-creasing the environmental impact of such products.

The example lined out above with respect to tires is similarly applicable to other used products such as used battery, used car, used textile, used mattress, used car component or the like.

For example, in the case of batteries, the logic as described herein may be applied. The re-use trigger may be provided as described in the context of FIGS. 6-8. The physical and/or chemical property may relate to a measured property of the used battery. For example, the measured property may relate to a damage status such as derivable from image data or charge-discharge cycles. The physical and/or chemical property may be determined from battery data collected via the at least one decentral identifier associated with the used battery. For example, the battery data may relate to the composition of the cathode active material of the battery signifying the chemical property of the battery. Based on the physical and/or chemical property control and/or monitoring data may be generated by correlating and/or relating the at least one physical and/or chemical property of the used battery to processing properties of one or more apparatus(es) configured to re-use the used battery and/or by generating machine-readable instructions for processing the used battery by one or more apparatus(es) configured to re-use the used battery. Processing properties of one or more apparatus(es) configured to re-use the used battery may relate to and/or be correlated with physical and/or chemical properties of the battery. For example, if the used battery exhibits physical damage, the battery may not be repurposed and provided for recycling. Further for example, if the capacity e.g. as derivable from charge-discharge curves measured for the used battery is below a threshold e.g. of 20-30% below the capacity of an equivalent unused battery, the battery may be repurposed for second life application. For example, an electric vehicle battery may be repurposed as buffers in energy grid applications. Further for example, if the capacity e.g. as derivable from charge-discharge curves measured for the used battery is below a threshold e.g. of 40-70% below the capacity of an equivalent unused battery, the battery may be recycled. Further to the physical and/or chemical property of the battery, recyclate data relating to recyclate flow to be refed into production of the one or more producer(s) may be collected e.g. from nodes associated with chemical producers. If recyclate flow associated with recyclable components of the used battery are required to produce new materials, control and/or monitoring data for recycling may be generated.

Further for example, in the case of textiles, the logic as described herein may be applied. The re-use trigger may be provided as described in the context of FIGS. 6-8. The physical and/or chemical property may relate to a measured property of the used textile. For example, the measured property may relate to a damage status such as derivable from image data. The physical and/or chemical property may be determined from textile data collected via the at least one decentral identifier associated with the used textile. For example, the textile data may relate to the composition of the textile fiber signifying the chemical property of the textile. Based on the physical and/or chemical property control and/or monitoring data may be generated by correlating and/or relating the at least one physical and/or chemical property of the used textile to processing properties of one or more apparatus(es) configured to re-use the used textile and/or by generating machine-readable instructions for processing the used textile by one or more apparatus(es) configured to re-use the used textile. Processing properties of one or more apparatus(es) configured to re-use the used textile may relate to or be correlated with physical and/or chemical properties of the textile. For example, if the textile exhibits no damage, the textile may be resold. Further for example, if the used textile exhibits physical or chemical damage, the textile may be repurposed as insulating or stuffing material or, if based on the textile composition unsuitable for repurpose, provided for textile recycling. Further to the physical and/or chemical property of the textile, recyclate data relating to recyclate flow to be refed into production of the one or more producer(s) may be collected e.g. from nodes associated with chemical producers. If recyclate flow associated with recyclable components of the used textile are required to produce new materials, control and/or monitoring data for recycling may be generated.

Other than the examples explicitly lined out herein, further examples and embodiments may be realized under the concept of the disclosure lined out herein. The explicit examples shall not be considered limiting and are mere illustrations of the concepts lined out herein.

The present disclosure has been described in conjunction with preferred embodiments and examples as well. However, other variations can be understood and effected by those persons skilled in the art and practicing the claimed invention, from the studies of the drawings, this disclosure and the claims.

Any steps presented herein can be performed in any order. The methods disclosed herein are not limited to a specific order of these steps. It is also not required that the different steps are performed at a certain place or in a certain computing node of a distributed system, i.e. each of the steps may be performed at different computing nodes using different equipment/data processing.

As used herein “determining” also includes “initiating or causing to determine”, “generating” also includes “initiating and/or causing to generate” and “providing” also includes “initiating or causing to determine, generate, select, send and/or receive”. “Initiating or causing to perform an action” includes any processing signal that triggers a computing node or device to perform the respective action.

In the claims as well as in the description the word “comprising” does not exclude other elements or steps and the indefinite article “a” or “an” does not exclude a plurality. A single element or other unit may fulfill the functions of several entities or items recited in the claims. The mere fact that certain measures are recited in the mutual different dependent claims does not indicate that a combination of these measures cannot be used in an advantageous implementation.

Any disclosure and embodiments described herein relate to the methods, the systems, devices, the computer program element lined out above and vice versa. Advantageously, the benefits provided by any of the embodiments and examples equally apply to all other embodiments and examples and vice versa.

All terms and definitions used herein are understood broadly and have their general meaning.

1. A method for processing at least one used product, the method comprising the steps:
providing at least one re-use trigger including at least one decentral identifier associated with the used product;
collecting at least one physical and/or chemical property of the used product, wherein the physical and/or chemical property is a measured property of the used product and/or wherein the physical and/or chemical property is determined from product data collected via the at least one decentral identifier associated with the used product;
generating control and/or monitoring data by relating the at least one physical and/or chemical property of the used product to processing properties of one or more apparatus(es) configured to re-use the used product and/or by generating machine-readable instructions for processing the used product by one or more apparatus(es) configured to re-use the used product; and
providing the control and/or monitoring data including the machine-readable instructions for processing the used product by one or more apparatus(es) configured to re-use the used product.

2. The method of claim 1, wherein the at least one physical and/or chemical property is collected by an optical measurement of the at least one physical and/or chemical property.

3. The method of claim 1, wherein the at least one physical and/or chemical property is collected by requesting product data associated with the used product via the at least one decentral identifier associated with the used product.

4. The method of claim 3, wherein the requested product data relate to monitoring data collected during use of the product, wherein the physical and/or chemical property is determined from the monitoring data.

5. The method of claim 3, wherein the requested product data relate to production data collected on production of the product, wherein the physical and/or chemical property is determined from the production data.

6. The method of claim 1, wherein the product data are collected from one or more network node(s) associated with one or more product producer(s) and/or user(s) connected via a decentral network, wherein the network node the product data are to be collected from is selected based on the decentral identifier associated with the used product.

7. The method of claim 1, wherein the processing properties of one or more apparatus(es) are collected from one or more network node(s) associated with product re-users connected via a decentral network, wherein the network node the processing properties of one or more apparatus(es) are to be collected from is selected based on at least one property of the used product.

8. The method of claim 1, wherein the one or more apparatus(es) configured to re-use the used product process the used product by re-purposing, refurbishing or recycling the used product.

9. The method of claim 1, wherein the processing properties of the one or more apparatus(es) configured to re-purpose or refurbish the used product relate to at least one physical property of the used product, wherein the processing properties of the one or more apparatus(es) configured to recycle the used product relate to at least one chemical property of the used product.

10. The method of claim 1, wherein recyclate data related to one or more recyclate composition(s) to be refed into a production of the one or more producer(s) is collected, wherein control and/or monitoring data is generated by relating the at least one physical and/or chemical property of the used product to recyclate data.

11. The method of claim 1, wherein machine-readable instructions for processing the used product include at least one decentral identifier associated with at least one apparatus configured to re-use the used product and at least one decentral identifier associated with the used product.

12. An apparatus for processing at least one used product, the apparatus including:
a trigger provider configured to provide at least one re-use trigger including at least one decentral identifier associated with the used product;
a data collector configured to collect at least one physical and/or chemical property of the used product, wherein the physical and/or chemical property is a measured property of the used product and/or wherein the physical and/or chemical property is determined from product data collected via the at least one decentral identifier associated with the used product;
a control data generator configured to generate control and/or monitoring data by relating the at least one physical and/or chemical property of the used product to processing properties of one or more apparatus(es) (806-812) configured to re-use the used product and/or by generating machine-readable instructions for processing the used product by one or more apparatus(es) configured to re-use the used product; and
a control data provider configured to provide the control and/or monitoring data including the machine-readable instructions for processing the used product by one or more apparatus(es) configured to re-use the used product.

13. A system for processing at least one used product, the system comprising:
an apparatus for processing the at least one used product according to claim 12 and at least one of the following apparatuses:
one or more apparatus(es) configured to re-use the used product;
a physical treatment apparatus for refurbishing the at least one used product or part(s) thereof;
a chemical and/or physical treatment apparatus for recycling the used product or part(s) thereof; and/or a chemical and/or physical treatment apparatus for recovering chemical material from the used product or part(s) thereof.

14. One or more chemical material(s) produced from the at least one used product or part(s) thereof by using the control and/or monitoring data generated according to the method of claim 1.

15. A method for controlling and/or monitoring re-use of at least one used product, and/or to refeed chemical material recovered from at least one used product into one or more chemical production process(es) comprising using the control and/or monitoring data provided according to the method of claim 1.

16. A method for controlling and/or monitoring re-use of at least one used product, and/or to refeed chemical material recovered from at least one used product into one or more chemical production process(es) comprising using the control and/or monitoring data provided by the apparatus of claim 12.
